(19) United States
(12) Patent Application Publication
(10) Pub. No.: US 2006/0214099 A1
(43) Pub. Date: Sep. 28, 2006

(54) Polymer entrapped particles

(76) Inventors: Richard David Oleschuk, Kingston (CA); Rui Xi Xie, Kingston (CA); Terrence Brian Joseph Koerner, Kingston (CA)

Correspondence Address: TORYS LLP, 79 WELLINGTON ST. WEST, SUITE 3000, TORONTO, ON, M5K 1N2, CA

(21) Appl. No.: 11/366,412

(22) Filed: Mar. 3, 2006

(30) Foreign Application Priority Data
Mar. 3, 2005 (CA) 2,499,657

(51) Int. Cl. H01J 49/00; B01D 59/44

(52) U.S. Cl. 250/281

(57) ABSTRACT

Emitters, compositions, and processes and methods for making emitters and compositions, useful for emitting sample for mass spectral analysis and/or acting as a stationary phase in chromatographic applications are described. Compositions according to the invention can comprise particles entrapped by polymer such that unoccluded channels are formed and the particles are substantially uncovered and able to interact with sample.

### FIELD OF THE INVENTION

The present invention relates generally to improved compositions which can alter a sample and produce plumes of charged molecules from an emitting end useful for analysis by mass spectrometry, and more specifically, it relates to particles entrapped within a polymer capable of producing said plumes, methods of making the compositions, and uses thereof.

### BACKGROUND OF THE INVENTION

Proteomic studies are becoming a very active area of post-genomic research because of the promise of uncovering biological markers to diagnose disease states as well as identifying proteins of therapeutic importance. This great potential for discovery has spurred many to develop new techniques to facilitate the identification of these target proteins in a high-throughput manner. Mass spectrometry has become an important analytical tool for protein studies because of its ability to determine the molecular weight of a protein with sufficient accuracy to enable identification of the protein. Furthermore, mass spectrometry possesses the ability to determine the primary structure of the protein with subsequent collision-induced dissociation (CID) experiments on the intact protein or its digested fragments [(a) Cristoni, S.; Bernardi, L, R.; Mass Spec. Rev. 2003, 22, 369-406. (b) Lill, J. Mass Spec. Rev. 2003, 22, 182-194. (c) Mann, M.; Hendrickson, R. C.; Pandey, A. Annu. Rev. Biochem. 2001, 70, 437-473. (d) Yates, J. R. J. Mass Spec. 1998, 33, 1-19].

In order to collect mass spectral information from protein or peptide samples of the analyte of interest must enter the mass spectrometer in the gas phase. Electrospray ionization provides a technique to facilitate the production of gas phase ions from the atmospheric pressure ionization of highly charged and nonvolatile compounds in a liquid sample. A solution in a capillary or microfluidic device under a strong electric field, in positive ion mode for example, will produce an accumulation of positive charge at the liquid surface located at the end of the device. At this point, the solution leaving the end of the device will undergo a change from spherical to elliptical and finally will form a Taylor cone that emits small droplets. This point occurs when the solution has reached what is called the Rayleigh limit. These smaller droplets then undergo desolvation and division to even smaller droplets until gas phase ions are produced which ultimately enter the mass spectrometer. A sensitive method of detection, which depends on the efficiency of the electrospray process, will maximize the amount of gas phase ions that are formed and reach the detector.

Electrospray techniques such as microelectrospray (microspray) and nanoelectrospray (nanospray) mass spectrometry involve the passage of samples at very low flow rates through capillaries that have been manufactured or pulled to produce a spray tip with a small inner diameter (2-10 micrometres). Flow rates of about 100 nL/min to 1 microlitre/min are generally used for microspray, and flow rates of <100 nL/min are generally used for nanospray.

With the advent of nanospray, it became possible to obtain mass spectral information about molecules such as peptides and proteins from an extremely small sample size, enhancing detection limits to the low femtomole and attomole levels. [(a) Wilm, M.; Mann, M. Anal. Chem. 1996, 68, 1-8. (b) Davis, M. T., Stahl, D. C.; Hefta, S. A.; Lee, T. D. Anal. Chem. 1995, 67, 4549-4556. (c) Valaskovic, G. A.; Kelleher, N, L.; Little, D. P.; Aaserud, D. J.; McLafferty, F. W. Anal. Chem. 1995, 67, 3802-3805]. While mass spectrometry has taken the lead as an analytical tool in proteomic studies because of the sensitivity of the instrument and the ability to gather structural information, the complexity of some samples to be analyzed requires extensive purification before analysis. Borrowing from the drug development process [(a) Hopfgartner, G.; Bourgogne, E. Mass Spec. Rev. 2003, 22, 195-214. (b) Strege, M. A. J. Chromatogr. B 1999, 725, 67-78], research in high-throughput protein analysis has relied on mass spectrometry coupled with automated separation techniques such as nanoliquid chromatography (nanoLC-MS) [Berger, S. J.; Lee, S.; Anderson, G. A.; Pa\check{s}a-Tolic, L.; Tolic, N.; Shen, Y.; Zhao, R.; Smith, R. D. Anal. Chem. 2002, 74, 4994-5000], and capillary electrophoresis (CE-MS) [Zhang, B.; Foret, F.; Karger, B. Anal, Chem. 2001, 73, 2675-2681].

Liquid chromatography (LC) traditionally utilizes a separation column filled with tightly packed particles with diameters in the low micrometer range. The small particles provide a large surface area, which can be chemically modified and forms a stationary phase. A liquid solvent or eluent, referred to as the mobile phase, is pumped through the column at an optimized flow rate that is based on the particle size and column dimensions. Analytes of a sample injected into the column flow through channels formed by the packed particles. The particles interact with the stationary phase relative to the mobile phase for different lengths of time, and, as a result, the analytes are eluted from the column separately at different times.

Capillary electrophoresis (CE) is a technique that utilizes the electrophoretic nature of molecules and/or the electroosmotic flow of liquids in small capillary tubes to separate analytes within a liquid sample. The capillary tubes are filled with buffer and a voltage is applied across it. It is generally used for separating ions, which move at different speeds when the voltage is applied depending on their size and charge.

Coupling of nanoLC and CE with MS has mostly been performed utilizing a pulled fused silica capillary (tip i.d. 2-10 micrometres), sometimes called a nanocapillary, to provide effective formation of an electrospray ionized (ESI) plume of ions. The main advantage of the pulled capillary is that small droplets are produced at the smaller openings at the end of the capillary. These smaller droplets have a larger surface to volume ratio, which produces a more efficient ionization process. In addition, the relatively small hydrophilic surface at the tip of the capillary reduces wetting of the surface and decreases the voltage needed to produce a stable electrospray. However, pulled silica capillaries have a strong tendency to clog, are difficult to fabricate reproducibly, and are not useful when coupled to separation techniques which require higher than a few microlitre/min flow rates.

Microchip technology (sometimes called lab-on-a-chip technology) has shown promise in the ability to automate many tedious protein purification and preparation steps before analysis. This technology is usually limited to optical detection of the purified proteins, which gives no structural information, and typically comprises a microchip coupled to an optical detector. The components on the microchip are moved from one part of the device to another by electroosmotic flow (EOF) and then pass through the detector. The coupling of such a microchip with a pulled capillary has been attempted in order to create a device that can be used to automate sample purification and analysis of protein or peptide samples by mass spectrometry. However, these first generation devices suffer from disadvantages including the inherent problems of the capillary itself as described above, and the fact that the coupling of the capillary with the chip must be precise in order to create a junction with zero dead volume. Such dead volume could adversely affect the separation efficiency of the device and subsequent sensitivity of the analysis of the sample. In addition, the coupling of a capillary to microchips or similar devices would be an expensive part in any future fabrication process.

An alternative to a capillary fixed to the end of a microchip is a microchip that has the ability to spray a purified sample directly from its end. This has been attempted with glass microchips but has met with limited success due to the large inner diameter of the exit channel of the microchip compared with nanospray capillaries and the hydrophilic nature of glass. Devices have been made with a nanospray nozzle directly fabricated into the microchip but these devices have not been in wide use which is likely due to the difficulty in manufacture and the potential for clogging of the nanospray capillary.

Recently, rigid porous polymer monoliths (PPMs), which are highly crosslinked polymers that have a high porosity, have shown great potential as stationary phases for both LC and CE applications. The PPMs are generally used instead of particles in a column. The pores, which are inherent throughout the PPM, form channels through which sample may flow. Samples are loaded at one end of the column and eluted through the column via the channels with an eluting solvent. Different components of the sample may interact chemically with the PPM for different lengths of time relative to the eluting solvent, which results in the separation of some components. The separated components are eluted from the column at the other end of the column (the eluting end) at different times. The use of PPMs for these systems is attractive because of the ability to modify the physical properties of the stationary phase and the ease at which these monoliths can be prepared. One such property that can be varied is the pore size within the PPM, which has been shown to vary from 0.5-1.5 μM in diameter depending on the properties of the casting solvent [Peters E. C.; Petro, M; Svec, F.; Fréchet, J. M. Anal Chem., 1998, 70, 2288-2295].

The size of the pores defined by PPM at the elating end of such columns have been shown to useful as nanospray emitters. If the sample is eluted at a suitable flow rate, a plume of the sample suitable for analysis by nanospray mass spectrometry is produced. The nanospray emitters prepared using porous polymer monoliths have been shown to function well for generating ESI at a variety of flow rates (Koerner, T.; Turck, K.; Brown, L.; Oleschuk, R. D.; Anal. Chem., 2004, 76, 6456-6460, herein incorporated by reference). However, PPM filled capillaries are not ideal for spraying samples of certain solvent compositions, such as aqueous samples.

The use of a PPM as a stationary phase has disadvantages from a chemical/physical standpoint including (i) the surface area of the PPM available to interact with components of a sample has been shown to be quite low and (ii) it is not amenable to being chemically modified.

### SUMMARY OF INVENTION

The invention provides emitters, compositions, and processes and methods for making emitters and compositions, useful, for example, for emitting sample for mass spectral analysis and/or acting as a stationary phase in chromatographic applications. Compositions according to the invention can comprise particles entrapped by polymeric material such that unoccluded channels are formed and the particles are substantially uncovered and able to interact with sample.

According to an aspect of the present invention, an emitter is provided comprising a plurality of particles collectively forming a plurality of channels, and a polymeric material adhesively disposed between at least a portion of adjacent said particles, wherein the channels are substantially unoccluded by the polymeric material. The polymeric material may form a porous polymer monolith or a substantially non-porous matrix. The polymeric material may be polyolefin, such as polyacrylate, polymethacrylate, polystyrene, or mixtures thereof.

According to another aspect of the present invention, a composition is provided comprising a plurality of particles collectively forming a plurality of channels, and a polymeric material adhesively disposed between at least a portion of adjacent said particles, wherein the channels are substantially unoccluded by the polymeric material. The polymeric material may form a porous polymer monolith or a substantially non-porous matrix. The polymeric material may be polyolefin, such as polyacrylate, polymethacrylate, polystyrene, or mixtures thereof.

In a particularly preferred embodiment of the present invention, a substantial amount of the surface area of the particles is uncovered by the polymer and available to interact with a sample.

According to another embodiment of the present invention, the particles may comprise at least one material selected from the group consisting of inorganic oxides, metal oxides, silica, alumina, titania, zirconia, chemically bonded inorganic oxides, chemically bonded metal oxides, organosiloxane-bonded phases, hydrosilanization/hydrosilation bonded phases, polymer coated inorganic oxides, porous polymers, polyolefin, polystyrene, polymethacrylate, polyacrylate, and styrene-divinylbenzene copolymer. The particles may be metal oxide-coated. The metal oxide-particles may comprise polyolefin, such as polystyrene. These particles may be coated with pepsin enzyme. These particles may be magnetic, such as paramagnetic.

According to another embodiment of the present invention, the particles may be porous or non-porous. The particles may have pores with a diameter in the range of about 100 to about 300 angstroms, greater than 300 angstroms, or less than 100 angstroms.

According to another aspect of the invention, the particles may have a diameter in the range of about 0.1 micrometres to about 1000 micrometres, or a diameter in the range of about 0.3 micrometres to about 600 micrometres, or a diameter in the range of about 0.5 micrometres to about 300 micrometres, or a diameter in the range of about 0.2 micrometres to about 30 micrometres.

According to another embodiment of the present invention, the channels have a diameter in the range of about 0.5 micrometres to about 10 micrometres, or a diameter in the range of about 1.0 micrometres to about 5.0 micrometres.

According to another embodiment of the present invention, the surface of at least one particle is suitable to interact with at least one component of a sample flowing through the channels.

According to another aspect of the invention, the emitter or the composition further comprise a vessel for containing the plurality of particles. The vessel may be a capillary. The inner diameter may about 0.2 to about 1000 micrometres, or about 30 to about 500 micrometres, or about 50 to about 250 micrometres, or about 1 to about 100 micrometres.

According to another aspect of the present invention, a use of an emitter is provided, the emitter comprising a plurality of particles collectively forming a plurality of channels, and a polymeric material adhesively disposed between at least a portion of adjacent said particles, wherein the channels are substantially unoccluded by the polymeric material to provide a sample suitable for analysis by mass spectrometry. The mass spectrometry may be micro-electrospray or nano-electrospray mass spectrometry.

According to another aspect of the present invention, a use of a composition is provided, the composition comprising a plurality of particles collectively forming a plurality of channels, and a polymeric material adhesively disposed between at least a portion of adjacent said particles, wherein the channels are substantially unoccluded by the polymeric material to provide a sample suitable for analysis by a mass spectrometer.

According to another aspect of the present invention, a use of a composition is provided, the composition comprising a plurality of particles collectively forming a plurality of channels, and a polymeric material adhesively disposed between at least a portion of adjacent said particles, wherein the channels are substantially unoccluded by the polymeric material for separating components of a sample.

According to another aspect of the present invention, a process for making a composition is provided, the composition comprising a plurality of particles collectively forming a plurality of channels and a polymeric material adhesively disposed between at least a portion of adjacent said particles, wherein the channels are substantially unoccluded by the polymeric material, the process comprising the steps of (a) introducing particles, monomer, and photo-initiator into a containment vessel that at least partly allows the transmittance of light, and (b) exposing the containment vessel to light. The containment vessel may comprise at least one section in which the composition is accessible to ultraviolet light and at least one section in which the composition is protected from the ultraviolet light.

According to another aspect of the present invention, products made by the processes of the present invention are provided.

### BRIEF DESCRIPTION OF THE FIGURES

The invention is illustrated in the figures of the accompanying drawings, which are meant to be exemplary and not limiting, and in which references are intended to refer to like or corresponding parts.

FIG. 1 is a schematic representation of a nanospray mass spectrometry system according to an embodiment of the present invention.

FIG. 2 is sectional view II of FIG. 1 showing a liquid junction in greater detail.

FIG. 3 is sectional view III of FIG. 2 showing one end of an electrospray emitter according to an embodiment of the invention.

FIG. 4 is a scanning electron micrograph representation of the cross-section viewed along IV-IV of FIG. 3. The scanning electron micrograph is a result of Example 1.2.2.

FIG. 5a shows a TIC trace of an electrospray sample of PPG sprayed from a nanospray emitter according to the present invention.

FIG. 5b is an electrospray mass spectral trace corresponding to the TIC trace of FIG. 5a.

FIG. 6 shows a solid phase extraction protocol (steps A-D) according to the present invention.

FIG. 7a shows the results of loading a 450 nM leucine enkephalin sample onto a sprayer according to the protocol depicted in FIG. 6.

FIG. 7b shows the linear relationship for the amount of leucine enkephalin loaded onto the sprayer and relative ion intensity measured at 556 m/z.

FIG. 8 shows the TIC traces and mass spectrum of a 50 nL 4.6×10-9 M sample of leucine enkephalin eluted at different flow rates.

FIG. 9 shows the results of a preconcentration experiment for 10 nM BODIPY sample on an entrapped particle column.

FIG. 10 shows a graph showing peak area versus sample concentration from the experiment related to that shown in FIG. 9.

FIG. 11 shows a preconcentration experiment using dilute 10 pM BODIPY sample solution.

FIG. 12 shows the results of an experiment similar to that shown in FIG. 9 but using BODIPY-FL.

FIG. 13 shows results which demonstrate the partial washing out of BODIPY-FL at pH 8 during a solid phase extraction experiment.

FIG. 14 shows a plot of fluorescence intensity versus time, showing flouorescence of Cy5 labeled leucine enkephalin sample during loading for a solid phase extraction experiment on a microchip.

FIG. 15 shows a graph of the peak area of fluorescence intensity versus loading time of 180 nM Cy5 labeled leucine enkephalin in a solid phase extraction experiment on a microchip.

FIG. 16 shows a microdevice according to an embodiment of the invention.

FIG. 17a shows a scanning electron micrograph of silica particles entrapped according to an embodiment of the present invention.

FIG. 17b shows an expanded region of the scanning electron micrograph shown in FIG. 17a.

FIG. 18a shows a scanning electron micrograph of ODS particles entrapped according to an embodiment of the present invention.

FIG. 18b shows an expanded region of the scanning electron micrograph shown in FIG. 18a.

FIG. 19 is an HPLC chromatogram showing the results of a preconcentration experiment according to an embodiment of the present invention.

FIG. 20 is a graph showing the signal enhancement obtained with different loading times of a sample on a column according to an embodiment of the present invention.

FIG. 21 shows an electropherogram of a capillary electrochromatography experiment of 16 polyaromatic hydrocarbons obtained according to an embodiment of the present invention.

FIG. 22 shows an electropherogram of a capillary electrochromatography experiment of 16 polyaromatic hydrocarbons obtained using different solvent conditions than those used in the experiment shown in FIG. 21.

FIG. 23 shows the cross-section of a packing manifold according to an embodiment of the present invention.

FIG. 24a shows a sample extracted ion chromatogram (XIC) showing the analysis of a PPG sample according to an embodiment of the present invention.

FIG. 24b shows an instant electrospray mass spectral trace of the PPG sample generated according to an embodiment of the present invention

FIG. 25 shows side-by-side scanning electron micrographs of ODS particles entrapped using a hydrophilic solvent (A) and a hydrophobic solvent (B) according to embodiments of the present invention.

FIG. 26 shows scanning electron micrographs of silica and ODS particles entrapped using different monomers and solvents according to embodiments of the present invention.

FIG. 27 shows scanning electron micrographs with corresponding schematic diagrams to the left of each of entrapped particles according to art-recognized methods (1 and 2) compared with methods according to the present invention (3).

### DETAILED DESCRIPTION OF THE PREFERRED EMBODIMENTS

The compositions of the present invention comprise particles entrapped in a polymeric material. The plurality of entrapped particles collectively form a plurality of channels. The polymeric material acts as an adhesive and is disposed between at least a portion of adjacent particles which causes the particles to be substantially immobilized relative to each other. The polymer does not substantially block the channels, leaving the channels substantially unoccluded by the polymer. In this composition, a substantial amount of the surface area of the particles is uncovered by the polymer and available to interact with a sample.

The compositions of the present invention are advantageously produced by a photo-initiation process. The particles are loaded into a vessel, as described below, and a solution including monomers, cross-linker and photo-initiator is added. The vessel is at least partly made from a material that allows the transmittance of ultraviolet (U.V.) light. The section of the containment vessel in which the composition of the present invention is desired is left accessible to U.V. light and the other sections are protected from the U.V. light. The methods disclosed herein provide substantially limited surface coverage of the particle to maximize the particle functionality. Such processes, as exemplified below, produce the compositions of the 1 present invention.

The compositions of the present invention are useful as emitters for electrospray mass spectrometry, including nanospray and microspray. Plumes of ions suitable for such analysis can be produced from the surface of the compositions by methods described below.

The compositions of the present invention are also useful as stationary phases for chromatographic procedures such as micro-high performance liquid chromatography (HPLC), gas chromatography (GC), and capillary electrochromatography (CEC). Other uses include solid phase extraction including preconcentration and sample cleanup, solid phase synthesis/catalysis/sample derivatization before analysis, catalyst immobilization (e.g. Pt or Pd spheres or coated particles) for catalyzed digestion of sample, enzyme reactor bed (e.g. trypsin immobilized spheres), and affinity separation (antibody-antigen, protein-affinity column). The particles used in the compositions of the present invention may be selected based on the desired chemical and/or physical characteristics. The stationary phases may be also used as nanospray or microspray emitters, or the composition may be coupled to another emission device for analysis of the components. Alternatively, the eluted compounds are analyzed separately.

The compositions of the present invention may be used with a variety of vessels such as glass capillaries or microchips.

The vessels, such as capillaries, may have inner diameters in the range of about 0.2 to about 1000 micrometres, more preferably in range of about 30 to about 500 micrometres, and even more preferably in the range of about 50 to about 250 micrometres. The vessels may have an inner diameter in the range of about 1 to about 100 micrometres.

Customized vessels are also within the scope of the present invention, wherein particles with different chemical and or physical properties are used in one containment vessel, either in separate sections, or interspersed amongst one another.

The compositions of the present invention may be used for flow-through peptide synthesis, including combinatorial or rational synthesis, or protein enzymatic digestion. This use may include subsequent analysis of products emitted from the channels of composition via electrospray.

The methods disclosed herein allow for patterning of particular particles in specific areas, which generally cannot be done with other methods. The methods associated with entrapping particles are also generally completed in a shorter amount of time compared to other methods of entrapment (hours for polymers to days for sol gel). Sol gel methods can crack during the drying process and create voids in the material. The methods of the present invention are suitable for both small and large capillaries, whereas larger capillaries tend to show unpredictable results in sol gel encapsulation. The methods of the present invention also provide for the use of a wide range of polymerization conditions which enable the entrapment of a variety of different particles.

The methods and apparatus are suitable for scale-up procedures. For example, many vessels may be loaded at once with particles and a polymerization mixture.

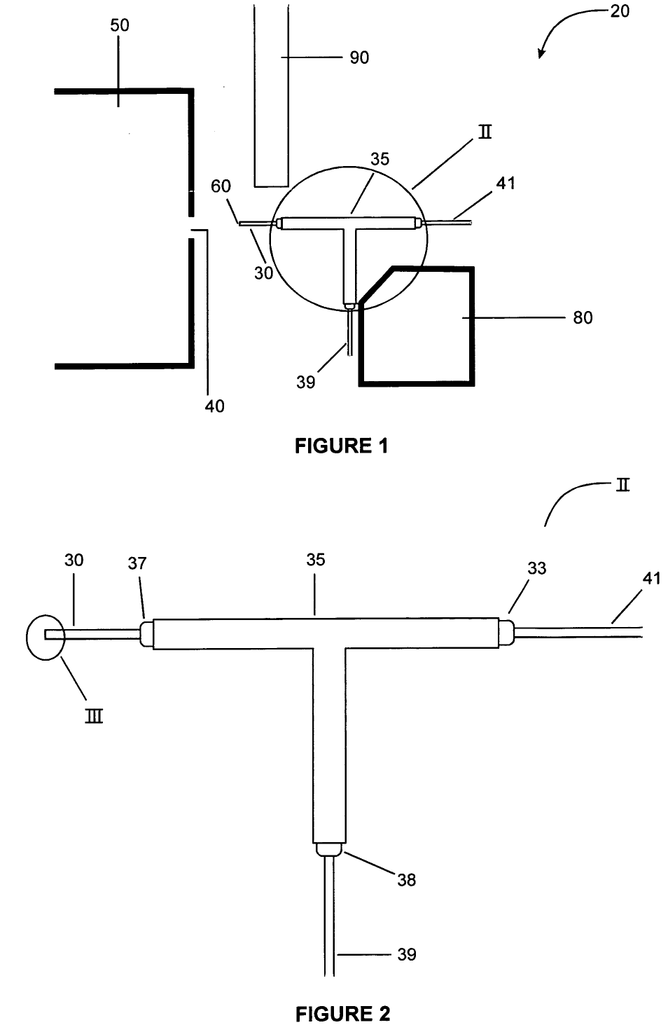

Referring now to FIG. 1, an electrospray mass spectrometry system in accordance with an embodiment of the present invention is shown generally at 20. The electrospray mass spectrometry system 20 comprises mass spectrometer 50 and electrospray emitter 30. Mass spectrometer 50 further comprises sample orifice 40 into which sample ions enter. Electrospray emitter 30 is attached to liquid junction 35 through which sample and/or solvent is delivered. Electrospray emitter 30 further comprises emitting end 60 from which the electrospray of the sample is emitted. Electrospray mass spectrometry system 20 further comprises x,y,z stage 80, to which electrospray emitter 30 is mounted, and C.C.D. camera 90, which are used to align the emitting end 60 to sample orifice 40. More than one camera may be used. The distance between emitting end 60 and sample orifice 40 should be within the range of about 0.2 to about 8.0 mm, more preferably within the range about 1.0 to about 6.5 mm, and most preferably within the range about 2.0 to about 5.0 mm.

In operation, the spray voltage may be in the range of about 0.5 to about 4 kV, more preferably in the range of about 0.6 to about 3 kV, and most preferably in the range about 0.7 to about 2 kV. The voltage on the emitter and the voltage applied to the system are the same and supplied via a liquid junction.

Referring now to FIG. 2, a sectional view of liquid junction 35 of view II in FIG. 1 is shown in greater detail. Liquid junction 35 is shown connected to solution transfer line 41 through connection 33. Solution transfer line 41 may be further connected to a syringe pump (not shown) or other pump for transferring solvent to emitter 30. Liquid junction 35 is also shown connected to electrode 39 through connection 38. Liquid junction 35 is preferably made of metal to allow application of electrospray voltage. Electrode 39 supplies the electrical connection and is further connected to a power source (not shown). Liquid junction 35 is also shown connected to emitter 30 through connection 37. Sample may be loaded into emitter 30 through solution transfer line 41.

Using the electrospray emitter of the present invention, components of a sample can be detected even when the concentration of the component is in the femtomole or even attomole range.

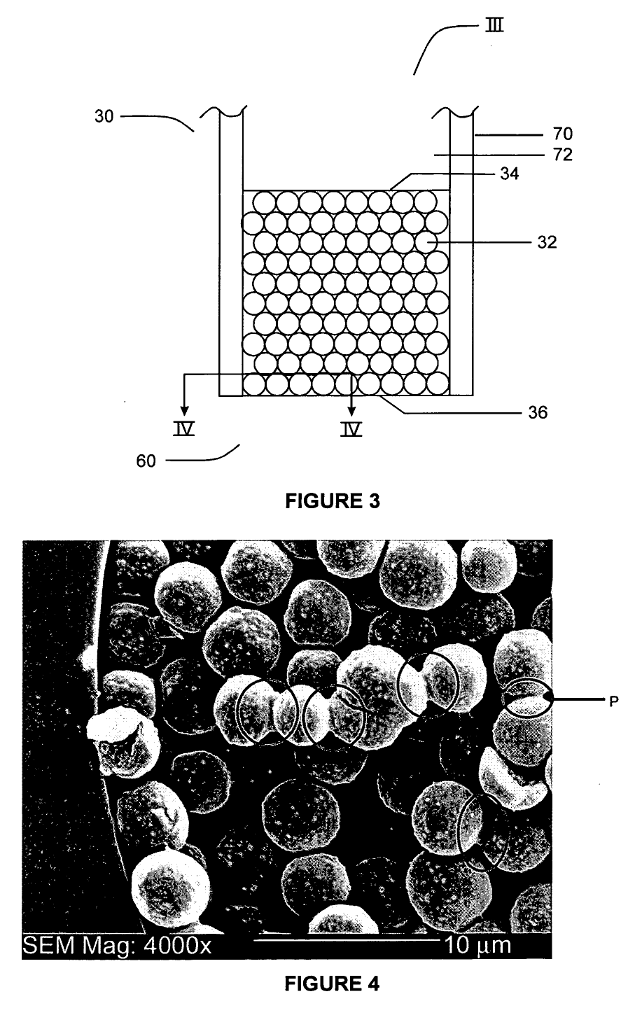

Referring now to FIG. 3, section III of electrospray emitter 30 identified in FIG. 2 is shown. Electrospray emitter 30 is shown further comprising vessel 70 which contains entrapped particles 32. Vessel 70 comprises channel 72 and is shown packed at emitting end 60 with entrapped particles 32. It should be noted that entrapped particles 32 can fill all of channel 72 depending on the application. The particles are entrapped by a polymer matrix through a polymerization process described below. The entrapped particles have a sample loading surface 34 and an emitting surface 36. A sample comprising such components as peptides and/or proteins can be transferred through channel 72 and onto sample loading surface 34 by various methods known in the art, such as by syringe pump or other pump via liquid junction 35. Electrospray emitter 30 is not necessarily used to alter a sample (i.e., change the relative concentrations of the components of a sample). The sample may be emitted as received and/or come directly from an high performance or pressure liquid chromatography (HPLC), nano liquid chromatography (nanoLC) or capillary electrophoresis (CE) through methods known in the art.

Sample solution volumes vary, but are in the range of about 50 to about 5000 nL, more preferably in the range of about 100 to about 3000 nL, and most preferably in the range of about 200 to about 1000 nL. Components in the sample solution may be in the concentration of about 1.0×10⁻¹⁸ M to about 1.0×10⁻² M, more preferably about 1.0×10⁻¹⁶ M to about 1.0×10⁻⁴ M, and most preferably about 1.0×10⁻¹⁵ M to about 1.0×10⁻⁴ M. The loading flow rate can range from about 200 to about 5000 nL/min.

The sample flows from sample loading surface 34 to emitting surface 36 by hydrodynamic force provided by such origins as a syringe pump, HPLC pump or nano LC pump. In the case of electroosmotic flow (EOF) experiments the flow is produced from the electroosmotic flow of the solution.

Suitable flow rates of the present invention include rates in the range of about 10 to about 10000 nL/min, more preferably in the range of about 50 to about 1500 nL/min, and most preferably in the range about 200 to about 1000 nL/min.

Pressures applied to entrapped particles 32 of this invention include pressures in the range of about 20 to about 8000 psi, more preferably in the range about 100 to about 4000 psi and most preferably in the range about 300 to about 1500 psi.

The amount of pressure used to pump the solution through the entrapped particles is proportional to the length of the path through the composition, i.e., the amount of entrapped particles through which the sample passes. Generally speaking, the longer the path, the higher the pressure.

Suitable inner and outer diameters of emitting end 60 include outer diameters in the range about 100 to about 5000 μm and inner diameters in the range about 5 to about 2500 μm, more preferably, the outer diameters are in the range about 100 to about 3000 μm and inner diameters are in the range about 20 to about 100, and most preferably the outer diameters are in the range about 150 to about 360 μm and inner diameters are in the range about 30 to about 75 μm. The surface area of emitting surface 36 will cover the entire area within the inner diameter of the capillary.

As used herein, the term “particles” refers to spheres, such as microspheres or spheres of any size, beads, cubes, and other three-dimensional structures of generally regular or irregular shape, and the like, and are generally commercially available, although modifications may be made before use. The particles may comprise a substrate of materials such as metal oxides, such as iron oxide, inorganic oxides, silica, alumina, titania and zirconia, chemically bonded inorganic oxides, such as organosiloxane-bonded phases hydrosilanization/hydrosilation bonded phases, polymer coated inorganic oxides or metal oxides, porous polymers, such as styrene-divinylbenzene copolymer, polyolefins, such as polyacrylates, polymethacrylates, and polystyrene. Particles may include, for example, octadecyl silane (ODS) particles, agarose beads, fluorinated beads, and silica based particles. The particles may be porous, mesoporous, or non-porous, or a combination. Porous or mesoporous particles may have pores of less than about 100 angstroms in diameter, in the range of about 100 to about 300 angstroms in diameter, or greater than about 300 angstroms in diameter, or a combination.

The particles may optionally bear substituents that confer desirable chemical properties, e.g. affinity, to the particles so that the particles are suitable for chromatography. Substituents may include, e.g., ketone groups, aldehyde groups, carboxyl groups, such as carboxylic acid, ester, amide, and acid halide groups, chloromethyl groups, cyanuric groups, polyglutaraldehyde groups, epoxide groups, thiol groups, amine groups, silanol groups, hydroxyl groups, sulphonic acid groups, phosphonic acid groups, and/or unsubstituted or substituted aliphatic or aromatic hydrocarbons. For example, for reversed-phase chromatography, alkyl, fluoroalkyl and phenyl bonded materials may be added; for ion-exchange chromatography, sulfonic acid, carboxylic acid, quaternary amine bonded or other materials may be added; for size-exclusion chromatography, glycerol bonded materials, poly(saccharide) and poly (dextran) gels may be added; for affinity chromatography, enzyme, antibody, lectin, and metal ion immobilized materials may be added. For example, particles may comprise nickel to attract molecules with histidine groups, or lectin to attract proteins with glycosylation sites.

The particles may be modified chemically and/or physically in order to be suitable for chromatography. The particles may be used without modification if they already have chemical and/or physical properties desirable for chromatography.

Different properties may be demonstrated by the same particles in different conditions, such as different solvent conditions.

The particles can comprise a magnetic material, such as a paramagnetic material, so that a magnet can be used to position the particles in a vessel before the photo-initiation step. Particles suitable for this application or other applications include metal oxide-coated polyolefin particles, such as iron oxide-polystyrene or magnetite-polystyrene particles.

The particles, including the magnetic particles, may be coated with pepsin, for example, such as the particles PMPE-4 (paramagnetic pepsin coated particles, 4 micrometres, Kisker Biotech, Steinfurt, Germany). The particles may also be coated with such groups as, e.g., avidin, streptavidin, albumin antibodies, such as goat anti-mouse IgG, papain, protein A, protein G, PEG-COOH, or PEG-NH₂ groups (all such magnetic particles available from, for example, Kisker Biotech, Steinfurt, Germany).

In one embodiment of the present invention, the entrapped particles can be used to digest proteins. In this embodiment, the materials must be stable to reagents used to digest proteins, such as enzymes, and suitable buffers such as trypsin.

Particle diameters may be in the range of about 0.1 to about 1000 micrometres, more preferably in the range of about 0.3 to about 600 micrometres, and most preferably in the range of about 0.5 to about 300 micrometres. Larger particles may be considered for specialized applications.

It is also contemplated that particles useful for peptide synthesis and/or combinatorial synthesis are applicable to other embodiments of the invention. In this case, particles for peptide synthesis and/or combinatorial synthesis can be entrapped within a vessel, such as a column or capillary, so that flow-through synthesis can be performed. A variety of active species attached to the particles and/or part of the solution, such as nucleophilic amino acids or amino acids with activated esters. Alternatively or in addition, solutions could be passed through a catalytic bed for continuous synthesis applications. It will be understood that such a process can also be adapted for syntheses such as small molecule synthesis or polynucleotide synthesis.

Entrapped particles 32 can function by chemically and/or physically interacting with components of an injected sample. Such interaction can result in a change in the relative composition and/or characteristics of the components of the injected sample from injection surface 34 to emitting surface 36.

The surface chemistry of the particles can be performed “off-line” and then integrated into the device or capillary. Possible interactions with components of the sample include hydrophobic, when the particles are functionalized with carbon 18 (C18), for example, and hydrophilic and/or electrostatic, when the particles are functionalized with sulfonic acids, for example. Other interactions include size exclusion interactions, where the particles comprise cavities or pores of varying sizes which interact with components of varying size within the sample and separates the components based on size.

Entrapped particles 32 need not chemically or physically interact with the sample at all, and may only function as providing suitable channels and/or pores for emitting the sample as a microspray or nanospray (described further below).

Electrospray emitter 30 comprises vessel 70, which may be a capillary suitable for the entrapment of particles in accordance with the present invention. Other suitable containment vessels include portions of a microchip as described below, Glass, such as fused silica, capillaries are preferred. Vessels which are commercially available may be used as received or may be modified by such techniques as pulling with a laser or manually with a microtorch to change its size or shape. For sufficient conductivity, the vessels may be sputter-coated with conductive material, e.g. gold, or a thin metal wire may be inserted into the capillary during operation of nanospray mass spectrometry system 20. The vessel should be made of a material which allows the passage of U.V. light in order to allow induction of the polymerization process (described below). The vessels may be made of material including glass, such as fused silicon, and plastics, such as polymethylmethacrylate (PMMA), polycarbonate and the like.

The compositions may be formed in any vessel, including, for example, a void in a device, such as a void in a microdevice. The void may be of any suitable shape, including, for example, a cubic void. Such compositions can be used for reactions in situ. For example, a composition of the present invention comprising trypsin enzyme coated particles may be made in a void or reservoir on the surface of a microdevice. In this case, the void or reservoir may be used as a digestion bed. The composition may be made by placing the particles in the void and then mixing with the polymerization mixture. Once the particles have settled by way of gravity or centrifugal force, to the bottom of the void, the composition may be formed by photo-intitiation. It is desirable in such a reaction to minimize the amount of oxygen available to react with the polymerization mixture. One method of minimizing the oxygen exposure is to degas the solvents before using them. The stationary composition could then be exposed to a solution of a suitable amount of protein for a suitable amount of time until a substantial amount of digestion products are left in the solution. The solution with the digestion products may then be removed via means known in the art, such as decantation or suction.

The particles are entrapped within the vessel by a polymer. Polymers suitable to use in accordance with this invention include any polymer or co-polymer mixture that can form a matrix. The matrix may be a porous polymer monolith including polyolefins, such as polyacrylates, polymethacrylates, polystyrenes, and the like. Alternatively, the matrix may be a substantially non-porous material, such as a material that is made by the polymerization of dimethacrylate without an additional polymer.

The polymer can advantageously be formed by exposing monomers to U.V. light in the presence of an appropriate solvent and photo-initiator. In this way, only selected portions of the vessel, such as a capillary may be submitted to the polymerization process, and therefore, only the selected portions of the vessel would contain the entrapped particles. The unreacted polymerization mixture can be washed away from the non-selected portions of the vessel. This process is referred to as “photo-patterning”.

Referring now to FIG. 4, a scanning electron micrograph image of a cross-sectional view along lines IV-IV from FIG. 3 is shown. FIG. 4 shows the entrapped particles and pores or channels throughout. As can be seen in these photographs, there is no polymer disposed within the channels. Some contact points P are circled. The inventors have discovered that photo-patterning a polymeric material with particles at the end of a capillary according to the invention provides a composition with the proper pore size and hydrophobic surface characteristics to facilitate a stable electrospray process while both reducing the possibility of dead volume and the likelihood of capillary clogging. Also, as a result of the photo-initiated polymerization process, the compositions of the present invention can be readily formed in specific regions of a capillary or device with reproducible “pores” or “channels” to facilitate either a single or multiple electrospray plumes enabling a stable electrospray over a large flow rate range. The photo-initiation process results in the polymer only being disposed between contacting points of the particles or between contacting points of the particles and vessel.

Suitable channel diameters with the present compositions include diameters in the range of about 0.2 to about 30 micrometres, more preferably in the range of about 0.5 to about 10 micrometres and most preferably in the range of about 1.0 to about 5.0 micrometres.

The channel diameters at emitting end 36 may be controlled by particle size. When the particles are tightly packed, the spaces between the particles form the channels which act as the electrospray emitters. The larger the spheres the larger the spaces between the spheres.

It will be understood by one skilled in the relevant arts that not all polymerization compositions or conditions will be suitable for use with all particles. For example, polystyrene-based particles, such as polystyrene spheres, may swell in the presence of certain polymerization compositions. However, it would not cause a skilled person to undertake undue experimentation to learn that using monomers and solvent conditions that are more hydrophilic can decrease the swelling of the polystyrene particles.

Embodiments of the present invention will now be described by way of examples. It will be understood that the scope of the invention is not limited by the specific embodiments exemplified herein.

### EXAMPLE 1

### Fabrication of Sprayer Incorporating Silica Particles Entrapped in a Polymer Matrix

1.1 Materials and Equipment

Fused-silica capillaries (about 75 μm i.d., about 363 μm o.d.) with a ultraviolet (U.V.)-transparent coating were obtained from Polymicro Technologies, L.L.C. (Phoenix, Ariz., US). Polymerization was performed using a Mineralight UV lamp, UVG-11 254 nm (Upland, Calif., US). A Harvard Apparatus 11 plus syringe pump (Holliston, Mass. US) was used to drive liquid through capillary or microchip. A Nikon Eclipse ME600 microscope (Tokyo, Japan) was used to monitor the particles packing and polymerization in the capillaries and microchip channels. Scanning electron microscopy (SEM) analyses were performed on a Jeol JSM-840 Scanning Microscope (Tokyo, Japan). All experiments were conducted at ambient temperatures.

Butyl acrylate monomer was obtained from Aldrich and filtered through freshly activated alumina to remove inhibitor. 3-(trimethoxysilyl)propyl methacrylate, 2-acrylamido-2-methyl-1-propanesulfonic acid (AMPS), 1,3-butanediol diacrylate (BDDA), and benzoin methyl ether (BME) were obtained from Aldrich and used as received. Buffer salt Tris was purchased from Fisher Scientific, while Tricine was obtained from Sigma. Buffers were prepared using ˜18.2 MΩ·cm deionized water filtered through a Milli-Q Gradient water purification system (Millipore S.A. Molsheim, France). Ethanol was purchased from Commercial Alcohols Inc. (Brampton, ON, Canada). Glacial acetic acid and HPLC grade acetonitrile and methanol were obtained from Fisher Scientific. 3 micrometre (μm) octadecyl silane (ODS) particles Microsorb 100-3 C18) were received as a gift from Varian Canada Inc. (Mississauga, ON, Canada).

All experiments were performed on an API 3000 triple quadrupole mass spectrometer (MDS-Sciex, Concord, Canada) fitted with a nanoelectrospray source (Proxeon, Odense, Denmark) consisting of a x-y-z stage and two Charge Coupled Device (CCD) camera kits to aid in the positioning of the capillary. A micro-Tee union (Scientific Products, Toronto, ON, Canada) was used to couple the solution transfer line, the electrospray capillary and the electrode necessary to supply the electrospray voltage. A syringe was filled with the solution to be analyzed and fitted to the transfer line of the micro-Tee union. The entire assembly was fixed to the x-y-z stage and the capillary was directed to the entrance of the mass spectrometer with the aid of CCD cameras. In most experiments the capillary was maintained approximately 5 mm from the orifice of the mass spectrometer (MS). The electrospray (ES) voltage was supplied through a liquid junction by connecting the MS power supply to a platinum electrode inserted within the micro-Tee.

1.2 Nanospray Emitter Fabrication

1.2.1 Particle Retaining Frit Fabrication

The nanospray emitters were prepared by first fabricating an outlet frit. The capillary was treated with 3-(trimethoxysilyl)propyl methacrylate for 8 hours to provide an anchor to the capillary wall. Following this, the polymerization mixture was introduced into the capillary or microchip channel with a syringe pump. The entire capillary or microchip was then masked leaving only 1.5 mm of the UV-transparent capillary or microchip exposed. The polymerization reaction was initiated by illuminating the exposed regions with 254 nm U.V. light for 1.5 minutes.

1.2.2 Particle Entrapment

Following frit formation, ODS particles entrapped in porous polymer matrix devices were prepared using the following procedure: ODS particles were introduced into either a capillary or microchip channel by a slurry packing method. This was followed by the introduction of the polymerization mixture into the capillary or microchip channel with a syringe pump. After several column volumes of the polymerization mixture had passed through the capillary or microchip channel, the packed beads were immobilized by exposing a specified region to about 254 nm U.V. light for about 2 minutes. The polymerization was followed by a washing step with a mixture of 80:20 v/v acetonitrile/5 mM tris buffer, pH 8 which was flushed through the capillary column with a syringe pump or nano-HPLC pump. The retaining frit was then removed by cutting the capillary in the bead-entrapped region. To observe the cross-section of the entrapped beads, a short length of the capillary column was cut off, coated with gold and observed by SEM. Results are shown in FIG. 4 and described above. The entrapped beads were found to be inherently stable and, once entrapped, were stable to greater than about 1500 pounds per square inch “psi” (>1500 psi) of pressure with no loss of sprayer integrity. Sprayers were used for more than three weeks with no loss in performance.

1.3 Preliminary Electrospray Performance

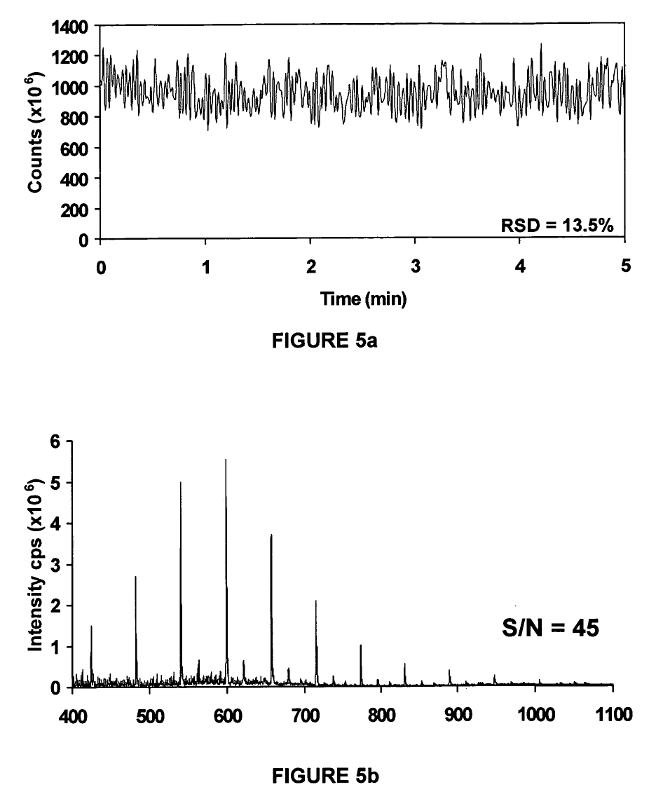

FIG. 5a shows a total ion current (TIC) trace and FIG. 5b shows a mass spectral trace for an electrospray generated by a nanospray emitter of the present invention. The TIC of the O-(2-aminopropyl)-O′-(2-methoxyethyl) polypropylene glycol 500 (PPG) sample is quite stable and yields a relatively clean mass spectrum from only about 40 femtomoles of material. In addition to the stable TIC traces using a co-solvent for spraying (i.e. acetonitrile (ACN) and water) the nanospray emitter performs considerably better than PPM filled capillaries when spraying aqueous samples.

The sprayer was tested with a number of different flow rates by examining the TIC traces and associated mass spectrum. Electrospray ionization (ESI) could be conducted over a very wide flow rate range. At flow rates ranging from about 100 nL-about 200 nL/min a single stable Taylor cone was observed which generated a stable TIC trace. Below about 200 nL/min a “mist” presumably due to multiple Taylor cones yielding a stable TIC signal. Below 50 nL/min the trace became significantly noisier however sufficient ions were still produced to enable mass spectral acquisition. A “clean” spectrum of leucine enkephalin was produced even at 10 nL/min.

The generation of an electrospray at these minimal flow rates shows the benefit of using the compositions of the present invention in microfluidic chips coupled to a mass spectrometer. Typically, microfluidic devices that utilize electroosmotic pumping deliver less than about 50 nL/minute flow rates.

### EXAMPLE 2

### Entrapped Particles of the Present Invention for Solid Phase Extraction (SPE)

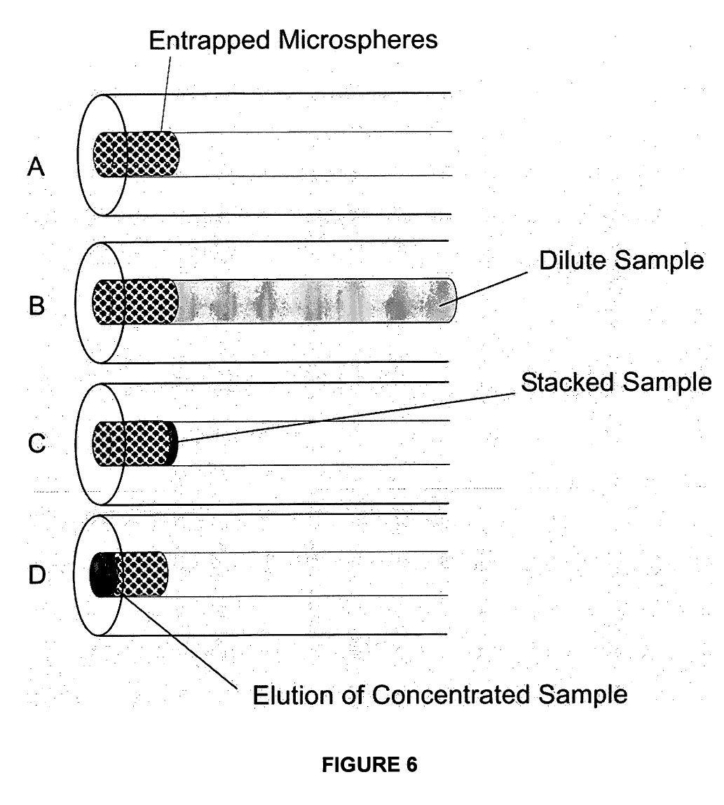

The surface chemistry of the particles can be exploited to perform sample preparation procedures to aid in MS analysis. To demonstrate the sample preparation capabilities of the composition of an embodiment of the present invention, solid phase extraction experiments were conducted. A schematic diagram depicting the SPE protocol is shown in FIG. 6. A vessel with entrapped particles is shown in step A. A peptide sample was pre-concentrated on entrapped ODS particles from an aqueous sample using a high flow rate (steps B and C). The concentrated sample was then eluted in a small volume of ACN (step D). An advantage of the capillaries photo-patterned with entrapped particles over conventional nanospray capillaries is that the flow can be increased well above a few tL/min with little backpressure in the system. In this way a sample can be rapidly flushed onto the entrapped particles and then eluted slowly with a stronger elutropic solvent.

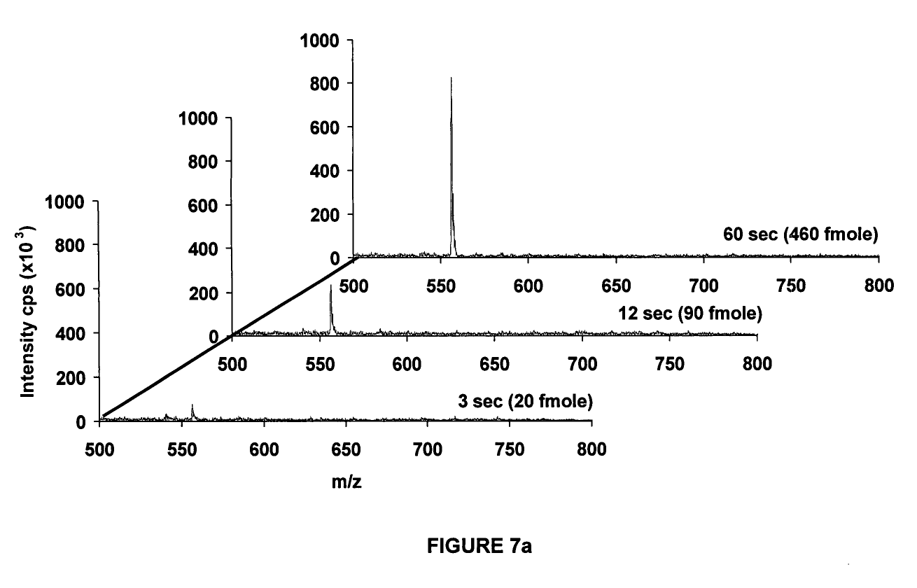

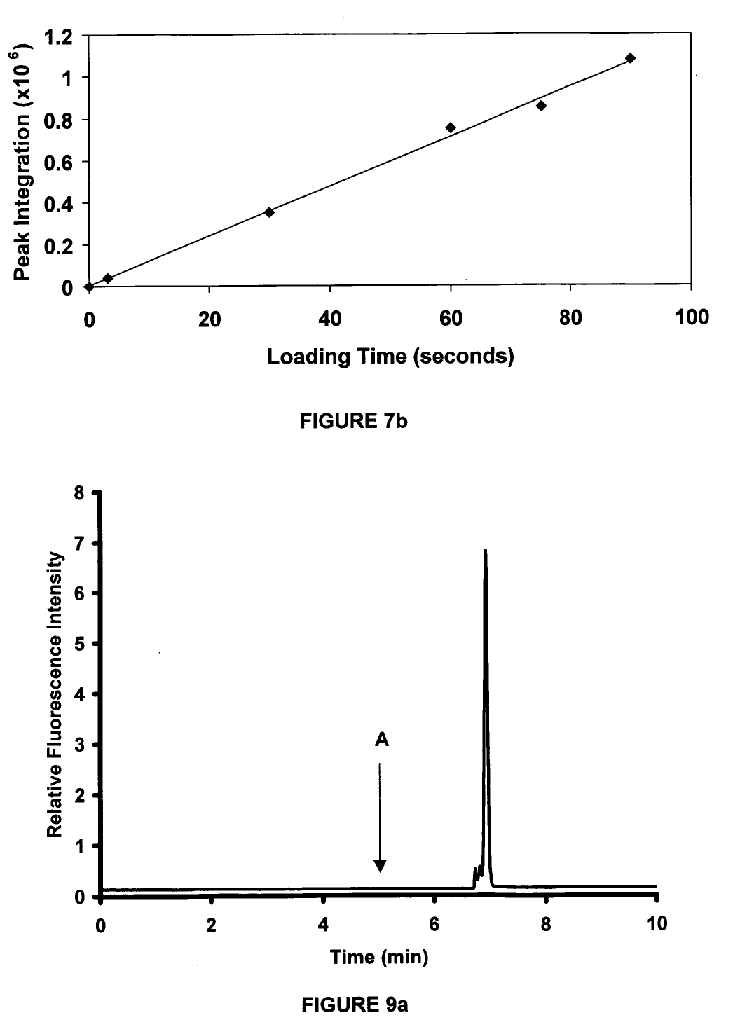

FIG. 7a shows the results of loading a 450 nM leucine enkephalin sample onto the sprayer at a flow rate of 800 nL/min according to the protocol depicted in FIG. 6. The loading was varied for different lengths of time followed by its elution with about 70% ACN. The 60 second loading experiment results in a significant concentration factor. FIG. 7b shows the linear relationship for amount of peptide loaded onto the sprayer and relative ion intensity measured at about 556 m/z.

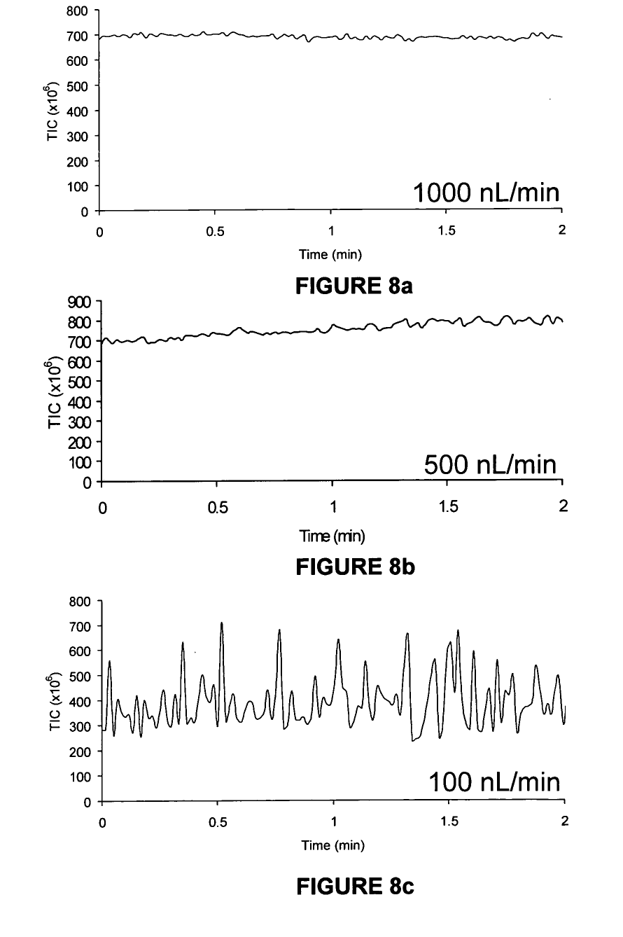

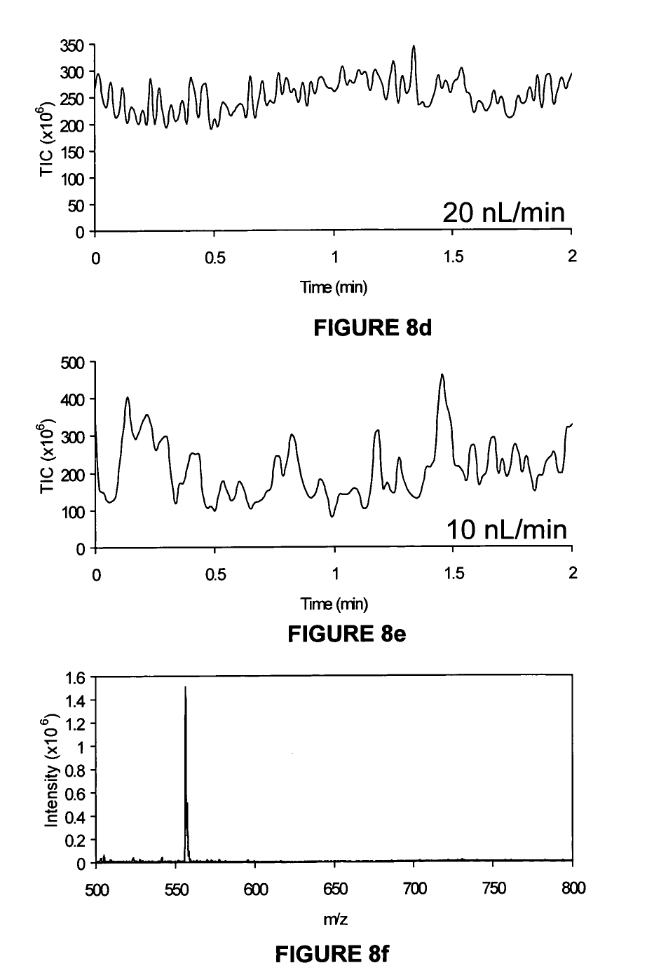

FIG. 8 shows a about 50 nL 4.6×10⁻⁹ M sample (i.e. 240 attomoles) of leucine enkephalin that was loaded onto the sprayer in about 100% aqueous and later eluted with about 70% ACN at different flow rates (A-E) and a resulting mass spectrum (F) derived from TIC(E). This demonstrates the ability to concentrate extremely small amounts of protein onto the sprayer followed by facile MS detection.

Although SPE with ODS functionalized particles was performed, a variety of commercially available particles possessing a variety of surface chemistries could be utilized.

### EXAMPLE 3

### Solid Phase Extraction Experiment with BODIPY®

A series of solid-phase extraction (SPE) experiments were conducted with of trace amount of BODIPY® and BODIPY®FL. The composition of this embodiment of the present invention fabricated in a capillary showed better performance than another two particle immobilization technologies (the packed column with a single frit, the packed column with an inlet and outlet frit) in terms of reproducibility and robustness.

3.1 Apparatus and Reagents

All the CEC experiments in capillaries were performed on a Beckman Coulter P/ACE MDQ capillary electrophoresis system (Fullerton, Calif., US) equipped with a laser-induced fluorescence (LIF) detector (about 488 nm excitation, about 520 nm emission). Fused-silica capillaries (about 75 μm i.d., about 363 μm o.d.) with a UV-transparent coating were obtained from Polymicro Technologies, L.I.C. (Phoenix, Ariz., US). Polymerization was performed using a Mineralight UV lamp, UVG-11 254 nm (Upland, Calif., US). A Harvard Apparatus 11 plus syringe pump (Holliston, Mass., US) was used to drive liquid through the capillary. A Nikon Eclipse ME600 microscope (Tokyo, Japan) was utilized to inspect the particles packing and polymerization in the capillaries. Scanning electron microscopy (SEM) analyses were performed on a Jeol JSM-840 Scanning Microscope (Tokyo, Japan). All experiments were conducted at ambient temperature.

Butyl acrylate monomer was obtained from Aldrich and filtered through freshly activated alumina to remove inhibitor (monomethyl ether hydroquinone). 3-(trimethoxysilyl)propyl methacrylate, 3-methacryloxypropyltrimethoxysilane, 2-acrylamido-2-methyl-1-propanesulfonic acid (AMPS), 1,3-butanediol diacrylate (BDDA), and benzoin methyl ether (BME) were all obtained from Aldrich and used as received. The buffer salt, Tris, was purchased from Fisher Scientific, while Tricine was obtained from Sigma. Buffers were prepared using −18.2 MS2·cm deionized water filtered through a Milli-Q Gradient water purification system (Millipore S. A. Molsheim, France).

Ethanol was purchased from Commercial Alcohols Inc. (Brampton, ON, Canada). Glacial acetic acid and HPLC grade acetonitrile and methanol were obtained from Fisher Scientific. 31.tm ODS particles (Microsorb 100-3 C18) were received as gift from Varian Canada Inc. (Mississauga, ON, Canada). 4,4-difluoro-1, 3, 5, 7, 8-penta methyl-4-bora-3a,4a-diaza-(S)-indacene, (BODIPY 493/503) and 4,4-difluoro-5,7-dimethyl-4-bora-3a,4a-diaza-s-indacene-3-propionic acid (BODIPY®FL) were purchased from Molecular Probes, Inc. (Eugene, Oreg., US).

3.2 Packed Column Fabrication

Packed column with one frit: To prepare an outlet fit, a short length of porous polymer monolith was prepared in a way similar to the method previously described by Ngola et al. [S. M. Ngola, Y. Fintschenko, W. Y. Choi, and T. J. Shepodd, Anal. Chem, 73 (2001) 849]. The capillary walls were first pretreated by grafting with vinyl groups to ensure that formed polymer will be covalently attached to the wall: the capillary was filled with a solution of 3-methacryloxypropyltrimethoxysilane (about 20%, all quantities are volume percent unless otherwise stated), glacial acetic acid (about 30%), and deionized water (about 50%) and left to react for 12 h, then washed and stored in a solution consisting ethanol (about 20%), acetonitrile (about 60%), and 5 mM phosphate buffer, pH 6.8 (about 20%). The polymerization mixture consisting of about 23% butyl acrylate monomer, about 10% BDDA as the cross-linker, about 0.2% AMPS to support electroosmotic flow, about 0.1% 3-methacryloxypropyltrimethoxysilane as additional adhesion promoter, about 0.2% (g/ml) BME as initiator, about 13.25% ethanol, about 40% acetonitrile, and about 13.25% 5 mM phosphate buffer, pH 6.8 as porogenic solvent, was introduced into the capillary with a syringe pump. The capillary was then covered by aluminum foil, leaving about 1.5 mm of the UV-transparent capillary exposed to the 254 nm UV light for about 1.5 min. To prepare a packed column with only one frit in a capillary, a slurry of 31.tm ODS particles in acetonitrile was then introduced into the capillary with pressure (immersed in a ultrasonic bath) to create a 2 cm long column.

Packed column with two retaining frits: After fabricating the outlet frit and 2 cm long column, the polymerization mixture was again introduced into the capillary with a syringe pump. After several column volumes of the polymerization mixture had passed through, the capillary was covered by aluminum foil, leaving a about 1.5 mm region of the capillary just at the open end of the packed particles exposed to the 254 mm UV light for about 1.5 min. Then a mixture of 80:20 v/v acetonitrile/5 mM tris buffer, pH 8 was flushed through the column with syringe pump to remove residual monomeric materials and porogenic solvent.

3.3 Entrapped Column Fabrication

Capillaries with ODS particles entrapped in a porous polymer matrix were prepared using the following procedure after constructing the outlet frit, ODS particles were introduced into the capillary by slurry packing method to yield a about 2 cm long column. The polymerization mixture was introduced into the capillary again with a syringe pump. After several column volumes of the polymerization mixture had passed through the capillary, the packed beads were immobilized by exposing the 2 cm packed region to the 254 nm UV light for about 2 minutes. Then a mixture of about 80:20 v/v acetonitrile/5 mM tris buffer, pH 8 was flushed through the capillary column with a syringe pump to remove unreacted monomeric materials and porogenic solvent. To observe the cross-section of the column bed, a short length of the capillary column was cut with ceramic cutter, and allowed to dry in a desiccator to remove all water and solvents. Cross sectional images were then captured with a scanning electron microscope after the sample was sputter coated with gold.

3.4 Solid-Phase Extraction

Two analytes were chosen to demonstrate solid-phase extraction with columns described above. The 0.10 mM stock solutions of BODIPY 493/503 and BODIPY®FL were prepared in HPLC grade methanol, then were diluted in 10 mM tricine buffer, pH8 to desired concentrations.

SPE was carried out in three steps: first, diluted samples were loaded onto the chromatographic bed using pressure. Secondly, aqueous buffer was flushed through the capillary to wash sample remaining within the capillary onto the column. The analyte retained on the bed was then eluted with 80% acetonitrile in aqueous buffer. The fluorescence of BODIPY or BODIPY®FL was detected with a LIF detection system (488 nm excitation, 520 nm emission) of Beckman P/ACE MDQ CE placed just the downstream of the chromatographic bed. Between each extraction, the device was equilibrated by rinsing with aqueous buffer before a new loading step commenced.

3.5 Breakthrough Curves

In order to determine the total capacity of the SPE bed, breakthrough curves were obtained with a 10 nM solution of BODIPY and BODIPY®FL dye by injecting them individually onto an aqueous buffer equilibrated capillary column. Fluorescent signal of BODIPY or BODIPY®FL was recorded just the downstream of the bed using the LIF detector (488 nm excitation, 520 nm emission).

3.6 Results

The UV photopolymerization of solution of butyl acrylate, BDDA and AMPS required only few minutes at room temperature to complete which reduces the column fabrication time compared to thermal polymerization. An additional advantage was the ability to readily pattern the material through appropriate masking.

The sample preparation process resulted in the particles being scattered on the capillary surface. In contrast, ODS particles entrapped with organic polymer remained “packed” following capillary cutting (as shown in FIG. 4). The organic polymer matrix was observed between the beads that both “glued” them together and anchored the beads to the capillary wall. The formation of polymer at bead-bead and bead-capillary contact points presumably results from a surface energy minimum in these regions.

To test the mechanical strength of the entrapped beads, a 0.5 cm long bed with no outlet frit was fabricated and found to withstand a pressure more that 4,400 psi which is the maximum pressure generated by the HPLC pump. The high strength is attributed to the covalent attachment of the beads to one another and the surface of the capillary. As a result the packed capillary should be robust enough for most high pressure chromatographic and electrochromatographic applications.

To demonstrate the SPE capability of the ODS columns prepared with different methods, a dilute solution of BODIPY was concentrated on them. BODIPY is a highly hydrophobic dye showing a strong affinity to ODS particles in an aqueous environment and affords an intensive fluorescence emission at 520 nm, so it was chosen as the starting analyte to investigate the SPE characteristics of the different types of columns.

The ODS beads retained with one frit showed irreproducible SPE properties because the open end of the packed bed allowed the movement of chromatographic material. Although the packed bed with two retaining frits was reproducible in the first few days of use, the reproducibility gradually deteriorated in the further runs. After 4 days of use, the relative standard deviation (RSD) of integrated peak area of eluted analyte increased from 4.8% to 6.2%, while the R² of a linear regression of peak area versus sample loading time decreased from 0.9816 to 0.8479. This is due to the accumulated migration of particles resulting in void formation within the column. In contrast, the entrapped column showed much better reproducibility in SPE experiments. The RSD of integrated peak area of eluted analyte still remained at 4.2% after 5 days of use, while the R² of linear regression of peak area versus sample loading time remained at 0.9934. This is again believed to be due to organic polymer immobilizing the packed particles in place, preventing movement, resulting in a robust continuous extraction bed.

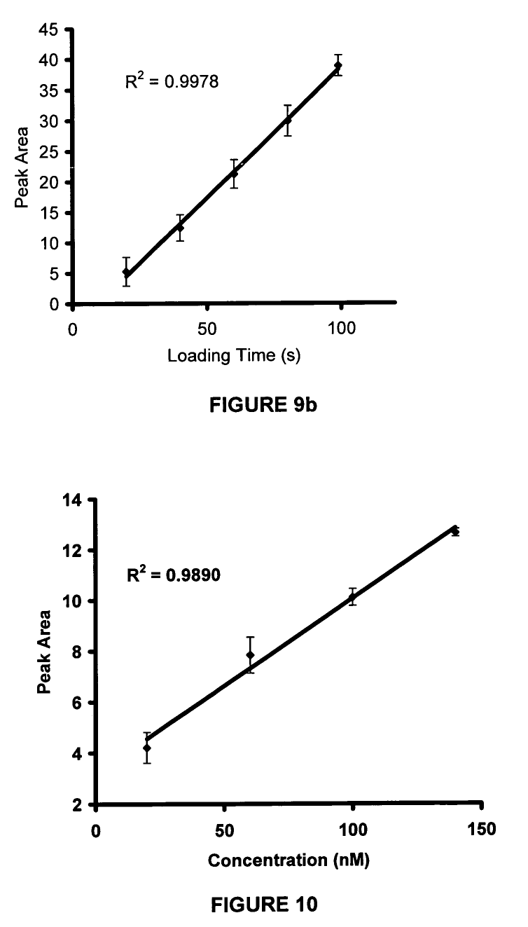

FIG. 9 shows a preconcentration experiment for 10 nM BODIPY sample on an entrapped column. Following bed equilibration with aqueous buffer, diluted samples were loaded onto the bed with pressure. After a five minute rinse step with aqueous buffer, about 80% of acetonitrile in aqueous buffer was then used to elute the preconcentrated BODIPY from the bed with EOF and pressure. It can be seen that BODIPY was eluted in a relative narrow band during the organic solvent elution step and no analyte was washed out during aqueous buffer wash step representing an ideal SPE process. Two experiments with different sample-loading times and different sample concentrations were performed to investigate the properties of the entrapped column. With preconcentration times ranging from 22 to 99 seconds, peak area plotted versus preconcentration time yielded a linear relationship (R²=0.9978) (shown in FIG. 9, inset). In experiments using different concentrations of sample (20 to 140 nM), peak area plotted versus sample concentration yielded a linear relationship (R²=0.9890) (shown in FIG. 10).

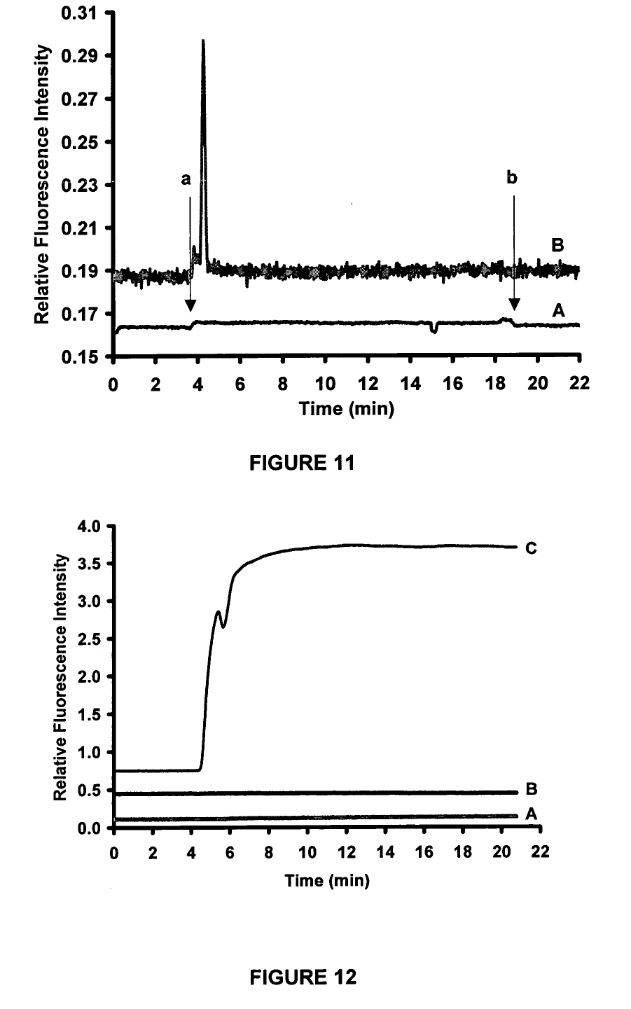

FIG. 11 shows a preconcentration experiment using a dilute 10 pM BODIPY sample solution. Trace A shows the resulting detection signal for a 10 pM BODIPY sample (80% acetonitrile/20% aqueous buffer) injected for 5 min (1.77×10⁻¹⁷ moles). An increase in fluorescence resulting from the sample entering the detector region can be seen at “a” and a corresponding decrease in fluorescence resulting after the sample has passed the detection region at “b”. In contrast, trace B shows the peak eluted following 15 min sample preconcentration on the entrapped column. The preconcentration factor can be calculated by dividing the volume of diluted sample with the volume of the eluent containing the eluted/concentrated sample. Since both sample loading and elution are carried out with the same pressure, the preconcentration factor equals to the ratio of the diluted sample loading time to the peak width of the eluted BODIPY. In this experiment, the resulting preconcentration factor was 44.

BODIPY®FL is more hydrophilic than BODIPY because of the caboxylic acid group in its chemical structure. In the same breakthrough experiment conditions as BODIPY, 10 nM BODIPY®FL showed a rapid and steep breakthrough (FIG. 12, trace C) while no noticeable breakthrough was observed by 10 nM BODIPY in pH8 (FIG. 12, trace A). Because the carboxylic acid group on BODIPY®Fl has a pKa around 4 and 5, it is partially deprotonated at pH8. By decreasing the pH of the solution, BODIPY®FL became protonated and more hydrophobic. Therefore it adsorbed more tightly onto the surface of the ODS beads as shown by the flat baseline-like fluorescent signal in the 22 min breakthrough experiment at pH 3.2 (FIG. 12, trace B).

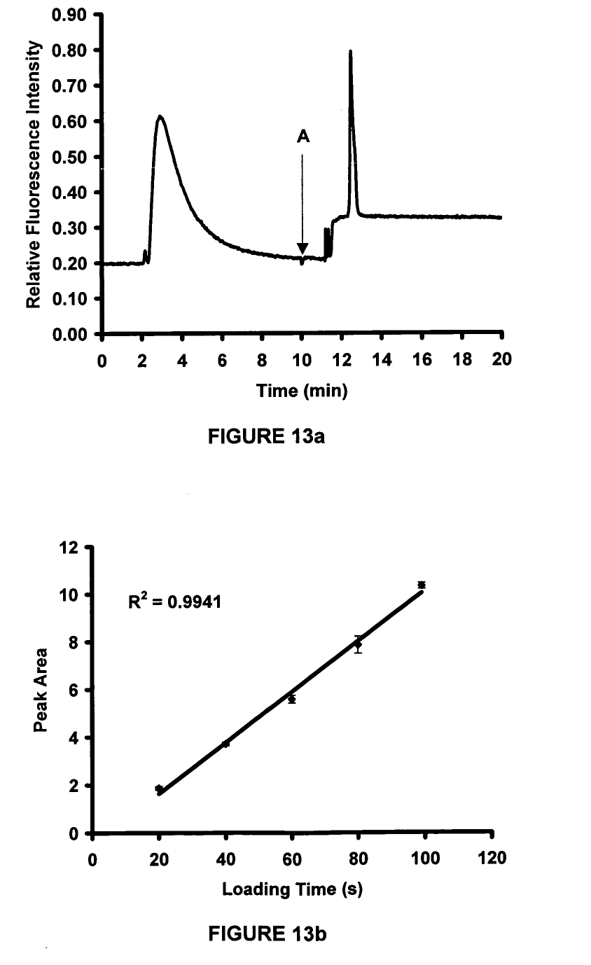

In the SPE experiment of BODIPY®FL at pH8.0, BODIPY®FL was observed to partially wash out during the aqueous buffer wash step (FIG. 13A). However, even with these nonoptimized SPE conditions, peak area of BODIPY®FL in the organic solvent elution step plotted versus preconcentration time still yielded a linear relationship (R²=−0.9941) over the studied conditions (FIG. 13B), indicating that the extraction characteristics of this organic polymer entrapped ODS beads column are predictable and reliable.

### EXAMPLE 4

### Solid Phase Extraction with a Microchip

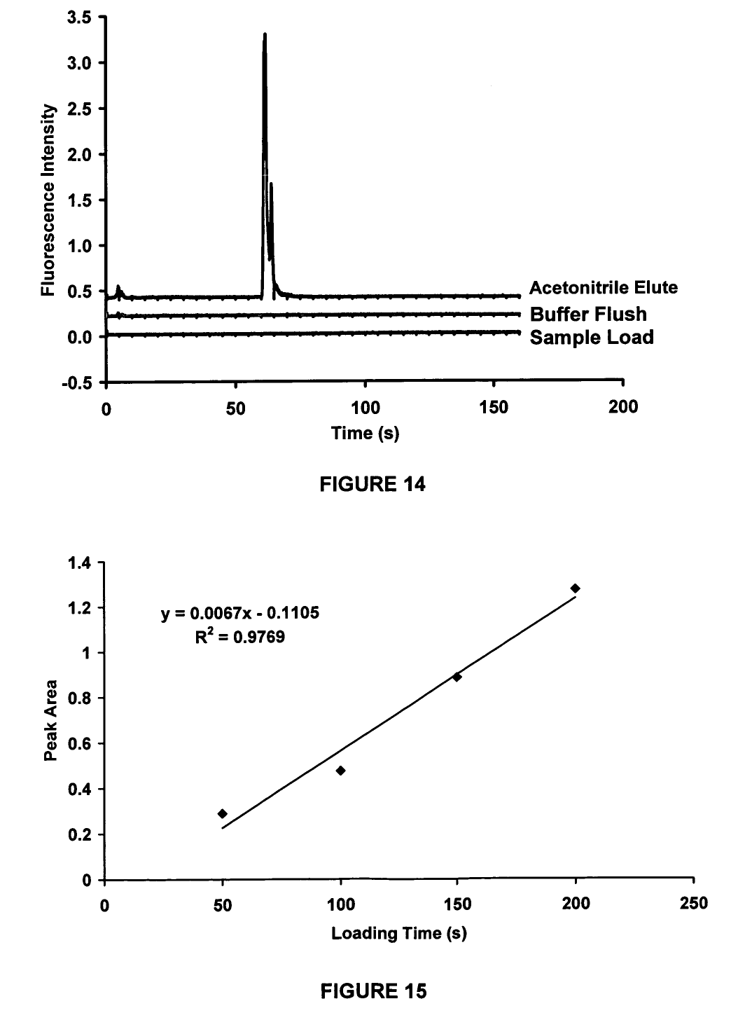

A SPE experiment of leucine enkephalin has been done with a composition of the present invention in microchip using Microfluidic Tool Kit (Micralyne, Edmonton, Canada). The kit consisted of a high-voltage power supply coupled with a laser-induced fluorescence (LIF) detection system (about 635 nm diode laser with 670 nm band pass filer). Since leucine enkephalin has no fluorescence emission at about 675 nm, it was labeled by Cy5 fluorescent dye in 0.1M sodium carbonate-sodium bicarbonate buffer, pH9.3 to make it detectable with a 675 nm LIF detector, and was then diluted to 180 mmol/L in 5 mM, pH8 phosphate buffer. SPE was carried out in three steps: (1) diluted samples were loaded onto the chromatographic bed with an electroosmotic flow (EOF) generated by a about 2.5 kV power applied across the microchip channel, (2) aqueous buffer was flushed through the channel to wash sample remaining within the channel onto the bed, and (3) the analyte retained on the bed was eluted with 80% acetonitrile in aqueous buffer. The fluorescence of Cy5 labeled leucine enkephalin was detected with the LIF detection system placed just the downstream of the chromatographic bed. Between each extraction, the device was equilibrated by rinsing with aqueous buffer before a new loading step commenced. FIG. 14 shows a plot of fluorescence intensity versus time, showing fluorescence of Cy5 labeled leucine enkephalin sample during loading, followind by a phosphate buffer flush and then elution with 80% acetonitrile in the 3-step preconcentration experiment for an 180 nM Cy5 labeled leucine enkephalin sample. The traces in FIG. 14 have been offset upward slightly to allow easier viewing. Different sample-loading times were utilized to investigate the properties of the extraction bed. In the preconcentration times ranging from 50 to 200 s, the integrated peak area plotted versus preconcentration time gave a linear relationship (R²=0.9769). FIG. 15 shows a graph of the peak area of fluorescence intensity versus loading time of the 180 nM Cy5 labeled leucine enkephalin.

### EXAMPLE 5

### Preparation of Microfluidic Chips

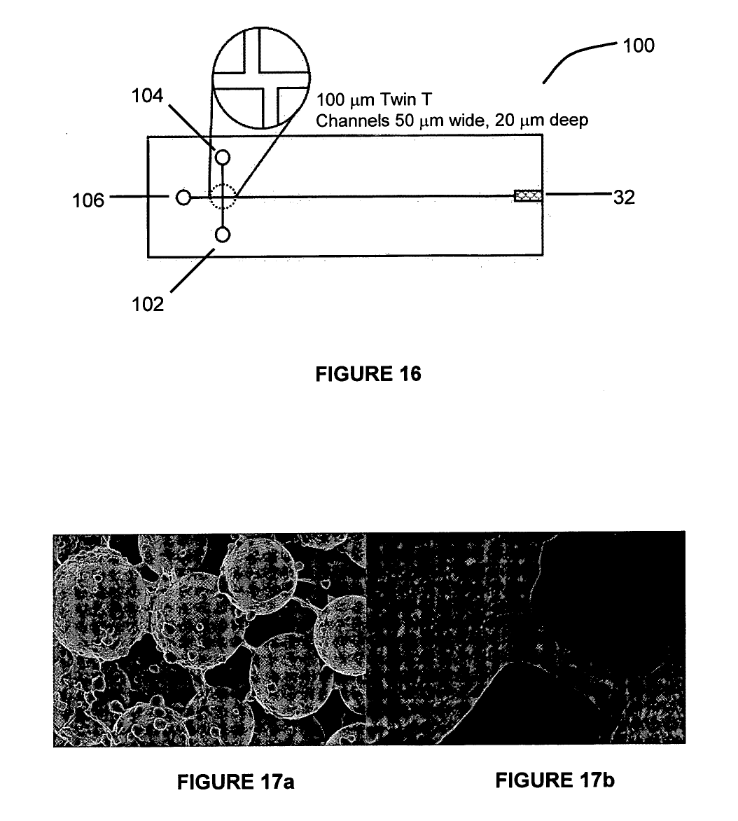

Particles are entrapped at the end of a plastic or glass microdevice according to methods of the present invention. FIG. 16 show microdevice 100 which can be sprayed directly into a mass spectrometer. The photo-patterning of entrapped particles 32 of the present invention reduces the possibility of dead volume. The microdevice is mounted to the micromanipulator and then positioned in front of the mass spectrometer. The peptide or protein sample is loaded into reservoir 102, and then a voltage is supplied between reservoir 102 and 104 to load the sample. A voltage and hydrodynamic flow is applied to reservoir 106 in order to move the sample to the mass spectrometer. The voltage is used for the electrospray process.

### EXAMPLE 6

### Trapping Silica Particles (3 Micron)

Silica particles of about 3 micrometers in diameter were trapped as generally described for ODS beads in Examples 3.1 to 3.3. To trap the silica particles in this example, some adjustments to the monomer conditions were made in order to make the mixture more hydrophilic. This was accomplished by increasing the sulfonic acid component from 1 to 40 percent of the monomer mixture.

6.1 Column Preparation

Fused-silica capillaries (363 μm o.d., 75 μm i.d.) with a U.V.-transparent coating (Polymicro Technologies Inc.) were pretreated by methods known in the art. A frit was then prepared in the capillary in a manner similar to the previous entrapment procedure.

In order to trap silica beads with minimal surface coverage, a more hydrophilic monomer solution was needed. This was accomplished by increasing the amount of sulfonic acid from 1 to 40 percent. This solution consisted of 2 mL casting solvent (1:1:3 ethanol: buffer pH=7: acetonitrile), 297 μL BDDA, 3 μL z-6030, 0.25 g AMPS, 516 μL butyl acrylate and 5 mg of benzoyl methyl ether. This solution was flushed through the capillaries and the beads were entrapped using 254 nanometer (nm) light for 90 seconds.

FIG. 17a is a scanning electron micrograph showing the silica particles entrapped by the method of Example 6. It can be seen from this figure that most of each particle is not covered with the polymer. FIG. 17b shows polymer acting as a bridge between two particles.

### EXAMPLE 7

### Trapping ODS Particles with No Monomer

The protocol described herein in Example 3 was used for this experiment, except in this experiment monomer was not included. In order to determine if ODS beads could be entrapped using only cross-linker (BDDA), all other components except for the casting solvent and initiator were removed from the system. This method used BDDA (300 μL) in 3.0 mL of casting solvent (1:1:3 ethanol: buffer pH=7: acetonitrile). This solution was flushed through the capillaries containing ODS beads and the polymerization was initiated using 254 nanometer light for 90 seconds,

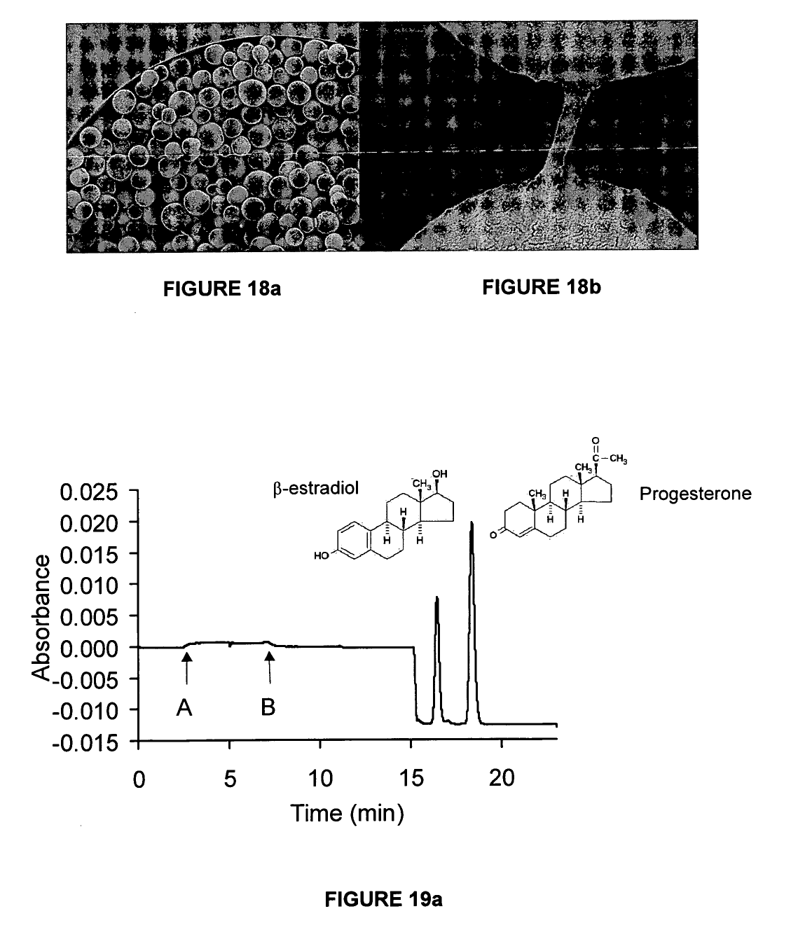

FIG. 18a shows a scanning electron micrograph showing the beads with unoccluded openings that in the great majority of cases lead to channels. Gold coating was used to make the beads visible by SEM. FIG. 18b shows that there is bridging between the particles even if monomer is not added to the polymerization mixture.

### EXAMPLE 8

### Solid Phase Extraction and Separation of Hormones

The experiment was performed to demonstrate the separation and solid phase extraction of two hormones. Hormones are a group of compounds that show important biological effects in living organisms. However, in many real applications, such as biological or environmental analysis, the low sample concentration usually impedes the accurate detection and quantitation of these compounds.

In this experiment, stock solutions of 4 millimolar (mM) beta-estradiol and 5 millimolar progesterone were prepared in HPLC grade acetonitrile (ACN), and were diluted in 3 millimolar tricine buffer, pH 7 to desired concentrations, Solid phase extraction was carried out in three steps on a 6 centimetre long column containing entrapped ODS particles (Microsorb 100-3 C18), First, diluted samples were loaded onto the chromatographic bed electrokinetically. Second, aqueous buffer was flushed through the capillary onto the column by applying voltage. Third, the analyte retained on the bed was then eluted by 70% ACN in aqueous buffer with EOF. The ultraviolet absorbance of beta-estradiol and progesterone was detected with a PDA (Photo Diode Array) detection system placed downstream of the chromatographic bed. Between each extraction, the device was equilibrated by rinsing with aqueous buffer before a new loading step commenced.

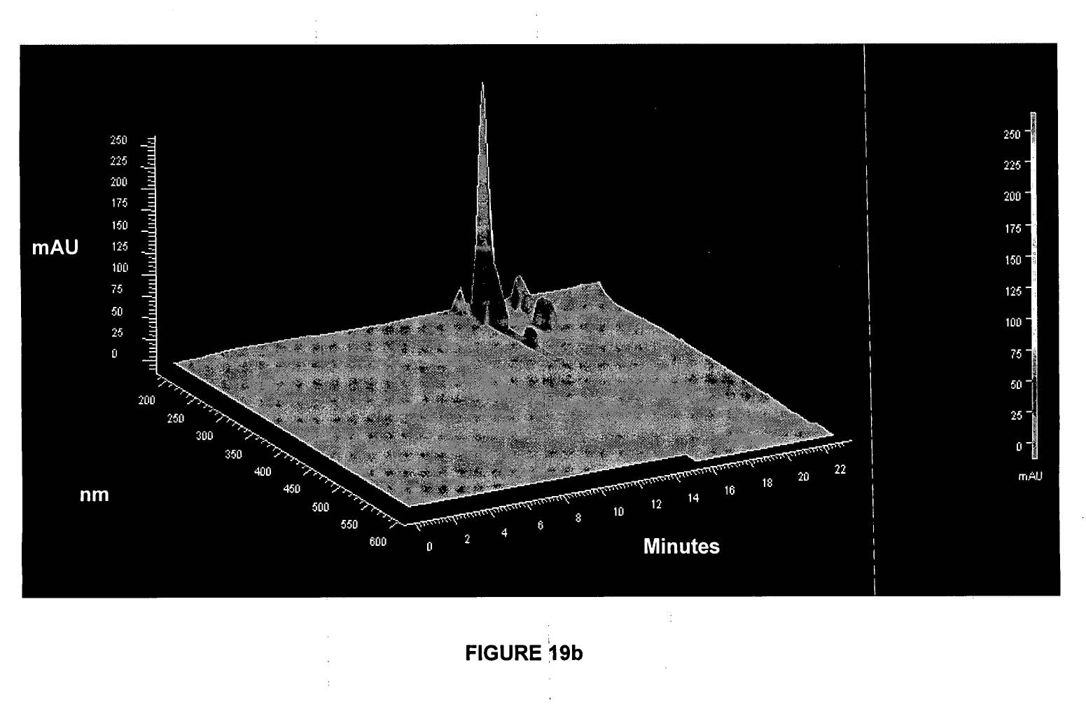

Following bed equilibration with aqueous buffer, diluted samples were loaded onto the bed electrokinetically by applying a voltage of 5 kilovolts for 5 minutes. After a 6 minute rinse step with aqueous buffer using voltage, 70% of ACN in aqueous buffer was then used to elute the preconcentrated beta-estradiol and progesterone with EOF. FIG. 19 shows the results of a preconcentration experiment for a sample containing 54.6 micromoles beta-estradiol and 22.9 micromoles progesterone on an entrapped column Before point A (0 to 5 minutes) sample loading is represented. The region from point A to point B (5 to 11 minutes) represents the wash step using 3 millimolar tricine buffer, pH 7. After point B (II to 23 minutes), the elution step using 70% ACN/30% 10 millimolar tricine buffer, pH 7, is represented. It can be seen that beta-estradiol and progesterone were eluted and separated into relatively narrow peaks during the organic solvent elution step, resulting in a signal enhancement of 102 for beta-estradiol when compared to the peak height of dilute sample, and an enhancement of 82 for progesterone.

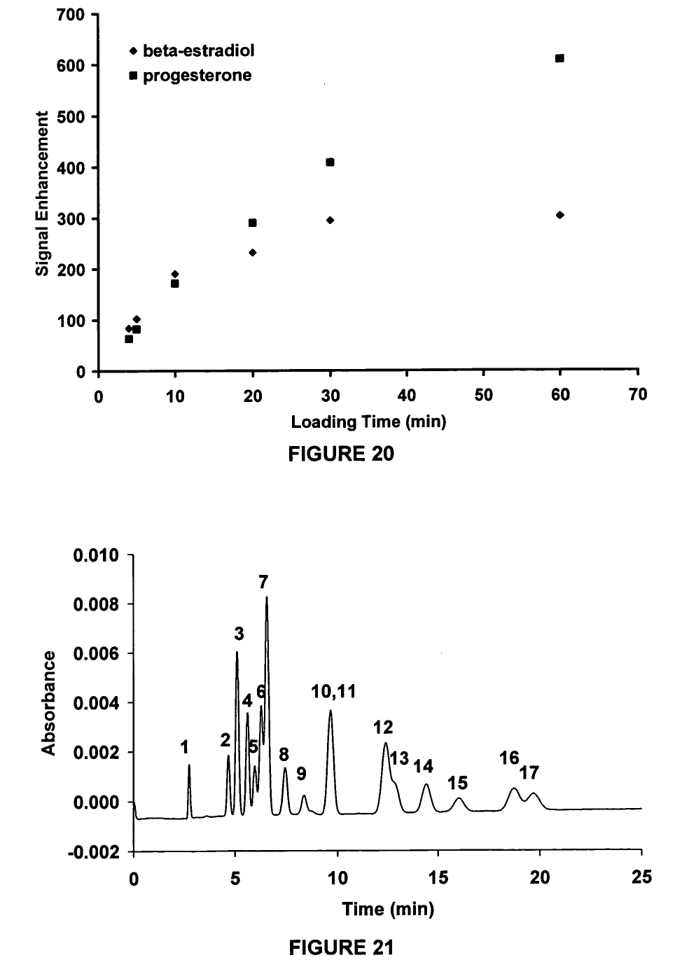

Different sample loading times were performed, and the result is shown in FIG. 20. FIG. 20 shows the signal enhancement obtained with different lengths of preconcentration on a 6 centimetre entrapped 3.0 micrometre ODS column. It can be seen from the figure that the signal enhancement versus loading time curve becomes nonlinear after 10 minutes and that the maximum signal enhancement is larger for progesterone relative to betaestradiol. The difference results from the relative hydrophobicities of the two hormones. Beta-estradiol is more hydrophilic than progesterone and therefore partitions to a lesser extent with the ODS particles resulting in both a faster elution and column saturation. Although the sample concentration used in the SPE experiment was relatively high, which was limited by the sensitivity of the PDA detector, signal enhancements of greater than 600 show the utility of the entrapped bead column.

### EXAMPLE 9

### Electrochromatography of a Polyaromatic Hydrocarbon (PAH) Mixture

This experiment showed the electrochromatography of sixteen polyaromatic hydrocarbons, namely naphthalene, acenaphthylene, fluorene, acenaphthene, phenanthrene, anthracene, fluoranthene, pyrene, benzo(a)anthracene, chrysene, benzo(b)fluoranthene, benzo(k)fluoranthene, benzo(a)pyrene, dibenzo(a,h)anthracene, indeno(1,2,3-cd)pyrene and benzo(ghi)perylene.

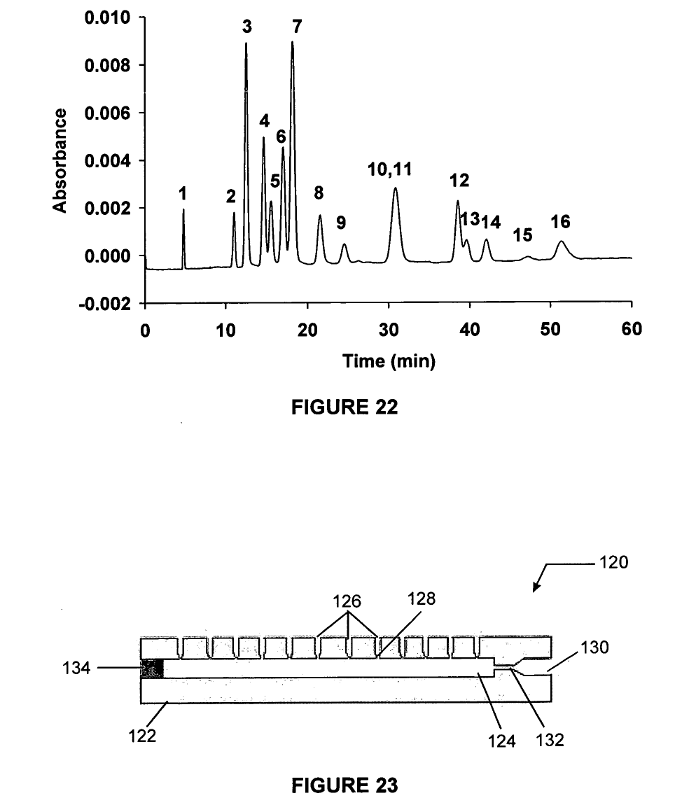

FIG. 21 shows a CEC electropherogram at 254 nm of EPA 610 PAHs (Supelco of Bellefonte, Pa.) mixture using a 6 cm long entrapped 3.0 μm ODS column. Sample loading: 2 kV, 3 sec; elution: 10 kV, with 80% ACN/20% 3 mM tricine buffer, pH 8. Peak identity: 1. thiourea (neutral marker), 2. naphthalene, 3. acenaphthylene, 4. fluorene, 5. acenaphthene, 6. phenanthrene, 7. anthracene, 8. fluoranthene, 9. pyrene, 10. benzo(a)anthracene, 11. chrysene, 12. benzo(b)fluoranthene, 13. benzo(k)fluoranthene, 14. benzo(a)pyrene, 15. dibenzo(a,h)anthracene, 16. indeno(1,2,3-cd)pyrene and 17. benzo(ghi)perylene. Since the CE instrument used in this experiment, Beckman Coulter P/ACE MDQ, could not perform gradient elution, only isocratic elution mode was employed in the separation. FIG. 21 shows that 15 peaks can be separated out of the 16 PAHs mixture (benzo(a) anthracene and chrysene were overlapped) with 80% acetonitrile. FIG. 22 shows the separation of the first 6 relatively hydrophilic compounds that was achieved by lowering the acetonitrile concentration to 70%. Although 16 compounds' baseline separations were not acquired, the separation ability of this entrapped microsphere column is demonstrated, considering the 6 cm long column length and the isocratic elution mode employed.

FIG. 22 shows a CEC electropherogram at 254 nm of EPA 610 PAHs mixture using a 6 cm long entrapped 3.0 μm ODS column. Sample loading: 2 kV, 3 sec; elution: 5 kV first 35 min, then 10 kV, with 70% ACN/30% 3 mM tricine buffer, pH 8. Peak identity: 1. thiourea (neutral marker), 2. naphthalene, 3. acenaphthylene, 4. fluorene, 5. acenaphthene, 6. phenanthrene, 7. anthracene, 8. fluoranthene, 9. pyrene, 10. benzo(a)anthracene, 11. chrysene, 12. benzo(b)fluoranthene, 13. benzo(k)fluoranthene, 14. benzo(a)pyrene, 15. dibenzo(a,h)anthracene and 16. indeno(1,2,3-cd)pyrene.

### EXAMPLE 10

### Multiple Nano-Sprayer Test (12 Capillaries Prepared in a Single Batch)

This experiment demonstrated that multiple particle-entrapped vessels can be prepared and used simultaneously. A 1×10⁻⁶ molar sample of PPG was injected into each of twelve capillaries and the results were analyzed by ESI-MS. The sample was injected into the capillaries using a constant infusion method. The experiment details are set forth below.

10.1: Materials and Protocols

Capillary: UV transparent, 360 μm OD, 75 μm ID

Number of capillary: 12 (use packing manifold)

Total length of capillary; 5.5 cm (2 capillaries are 4.5 cm and 4.7 cm long respectively)

Nanosphere: 3 μm ODS bead (100 Å)

Immobilized bead length: 1.1 cm

UV exposure time: 1.5 min

Distance between UV lamp to capillary: 3.5 cm

Power of UV lamp: 254 nm, 0.16 AMPS

Concentration of polypropylene glycol (PPG) solution: 1×10⁻⁶ M (solvent: ACN)

Parameters of ESI-MS

70% ACN flow rate: 500 nL min

IS voltage: 3 kV

Scan range: 400-1100 amu

Ion extraction range: 539.5-541 amu

10.2: Packing Manifold

FIG. 23 shows a cross section of a packing manifold shown generally at 120 which can be used for scale-up purposes. Packing manifold 120 comprises a body 122. Body 122 defines column 124. Body 122 further defines fitting holes 126 which are in communication with column 124 through capillary inlet 128. In this example, twelve fitting holes 126 are defined generally on one side of packing manifold 120. Fitting holes defined around packing manifold 120 (that is, not all generally on one side) may also be suitable in certain applications. Packing manifold 120 may comprise any suitable material such as PEEK (polyetheretherketone) or stainless steel and may be manufactured according to known methods, such as by standard machining methods or CNC (computer numerical control) milling. Packing manifold 120 further defines column inlet 130 which is in communication with column 124 through channel 132, Column inlet 130 is used as an entrance point for adding materials such as particles, solvents, monomer, photo-intitiator, and/or cross-linker to column 124. Plug 134 is inserted at one end in order to prevent any material from escaping column 124. Column inlet 130 may comprise spiral markings in order to sealingly engage with a vessel (not shown), such as a tube with corresponding spiral markings used to deliver the materials to column 124. During operation, capillaries (not shown) with a frit were inserted in each of the fitting holes and held in place with a ferrule, although any suitable securing means could be used. The particles were suspended in a polymerization solvent, forced by pressure through column inlet 130 and into column 124, through capillary inlets 128 and into the capillaries where they were packed with pressures of about 1500 psi. The capillaries were then released from the manifold, photo-intitiated and used in the testing described above. As would be understood by those skilled in the relevant arts, the photo-intitiation process can be alternatively conducted while the capillaries are secured to the manifold.

10.3 Results

The results are shown in Table 1. The average intensities of the PPG ions and the standard deviations demonstrate that the use of the polymer entrapped particles can be scaled up in manufacture and use without a substantial loss of reproducibility.

TABLE 1

| | PPG-2006-2 | |
|---|---|---|
| No. | Average Intensity | Std |
| Tip 1 (4.5 cm) | 1.40 × 10⁷ | 1.23 × 10⁶ |
| Tip 2 | 1.38 × 10⁷ | 1.15 × 10⁶ |
| Tip 3 | 1.56 × 10⁷ | 1.42 × 10⁶ |
| Tip 4 | 1.49 × 10⁷ | 1.16 × 10⁶ |
| Tip 5 | 1.32 × 10⁷ | 1.07 × 10⁶ |
| Tip 6 | 1.47 × 10⁷ | 1.25 × 10⁶ |
| Tip 7 | 1.40 × 10⁷ | 6.13 × 10⁶ |
| Tip 8 | 1.47 × 10⁷ | 1.54 × 10⁶ |
| Tip 9 (4.7 cm) | 1.48 × 10⁷ | 1.21 × 10⁶ |
| Tip 10 | 1.74 × 10⁷ | 1.33 × 10⁶ |
| Tip 11 | 1.27 × 10⁷ | 1.02 × 10⁶ |
| Tip 12 | 1.26 × 10⁷ | 0.94 × 10⁶ |
| Average of Average Intensity/Std | 1.44 × 10⁷ | 1.62 × 10⁶ |

### EXPERIMENT 11

### Multiple Nano-Sprayer Test (2 Capillaries)

This experiment demonstrated the reproducibility of the results of a 1×10⁻⁶ M sample of PPG emitted from two different nano-sprayer capillaries. The experimental details are set forth below.

11.1 Materials and Protocols

Nano-sprayer test

Capillary: UV transparent, 360 μm OD, 75 μm ID

Number of capillary: 2

Total length of capillary: 5.5 cm

Nanosphere: 3 μm ODS bead (100 Å)

Immobilized bead length: 1.1 mm

UV exposure time: 1.5 min

Distance between UV lamp to capillary: 3.5 cm

Power of UV lamp: 254 mm, 0.16 AMPS

Concentration of PPG solution: 1×10 M (solvent: ACN)

Parameters of ESI-MS

70% ACN flow rate: 500 nL/min

IS voltage: 3 kV

Scan range: 400-1100 amu

Ion extraction range: 539.5-541 amu

Back pressure: around 30 psi

11.2 Results

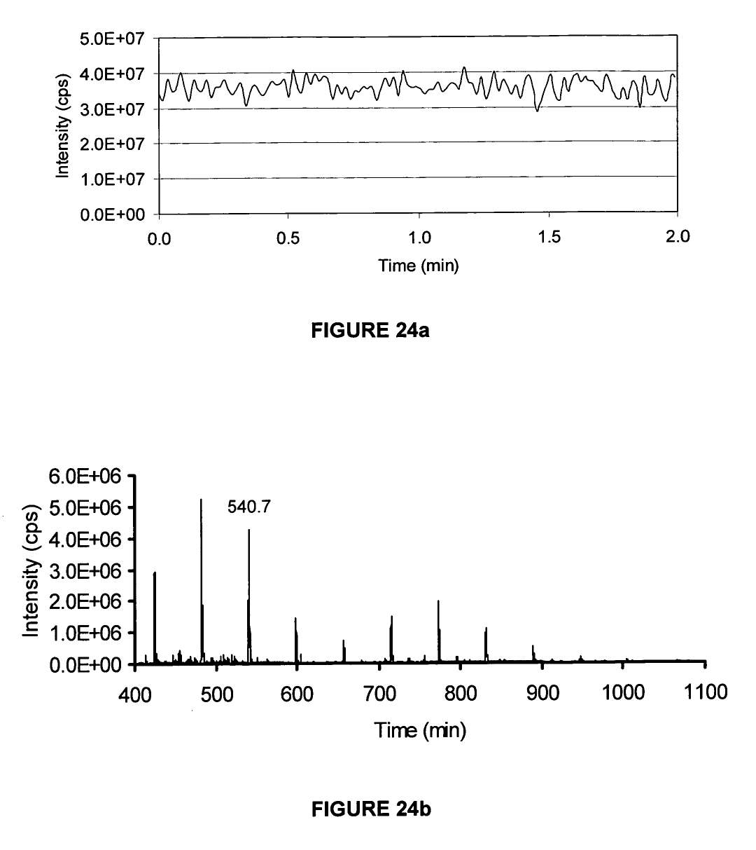

FIG. 24a shows an extracted ion chromatogram (XIC) in the range of 539.5-541 showing the analysis of the PPG (1×10 M) emitted from one emitter. FIG. 24b shows an instant electrospray mass spectral trace of the PPG sample generated by the emitter. Table 2 shows the average intensity and the standard deviation of the results.

TABLE 2

| No. | Average Intensity | Std |
|---|---|---|
| Tip 1 | 3.58 × 10⁷ | 2.46 × 10⁶ |
| Tip 2 | 2.16 × 10⁷ | 2.58 × 10⁶ |

### EXAMPLE 12

### The Optimization for Nanosprayers by C-18 Bead Size, Capillary Size and Flowrates

The data in Table 3 demonstrate a selection of suitable parameters in accordance with the present invention. The conditions used to obtain these data are described in Example 1.

TABLE 3

| | | Flowrate (nL/min) | | | | | |
|---|---|---|---|---|---|---|---|
| Capillary | | 500 | | 100 | | 50 | |
| Size OD-ID- | | Ave. | | Ave. | | Ave. | |
| Bead Size | | Intensity | | Intensity | | Intensity | |
| (μm) | | (cps) | Std | (cps) | Std | (cps) | Std |
| 360-75-3 | 1 | 2.49 × 10⁻⁷ | 1.26 × 10⁻⁶ | 1.01 × 10⁻⁷ | 8.62 × 10⁻⁵ | 1.06 × 10⁻⁷ | 1.03 × 10⁻⁶ |
| | 2 | 3.20 × 10⁻⁶ | 2.65 × 10⁻⁵ | 1.20 × 10⁻⁶ | 1.52 × 10⁻⁵ | 2.72 × 10⁻⁶ | 6.71 × 10⁻⁵ |
| 360-75-5 | 1 | 8.73 × 10⁻⁶ | 7.45 × 10⁻⁵ | Data N.A. | | Data N.A. | |
| | 2 | 7.77 × 10⁻⁶ | 5.79 × 10⁻⁵ | Data N.A. | | Data N.A. | |
| 360-75-16 | 1 | 2.49 × 10⁻⁷ | 1.20 × 10⁻⁶ | Data N.A. | | Data N.A. | |
| | 2 | 8.66 × 10⁻⁶ | 8.88 × 10⁻⁵ | Data N.A. | | Data N.A. | |
| 36-75-25 | 1 | 7.01 × 10⁻⁶ | 6.58 × 10⁻⁵ | Data N.A. | | Data N.A. | |
| | 2 | 6.44 × 10⁻⁶ | 5.68 × 10⁻⁵ | Data N.A. | | Data N.A. | |
| 150-75-3 | 1 | 2.76 × 10⁻⁶ | 5.29 × 10⁻⁵ | 6.79 × 10⁻⁶ | 4.50 × 10⁻⁵ | 4.49 × 10⁻⁶ | 2.75 × 10⁻⁵ |
| | 2 | 5.83 × 10⁻⁶ | 6.50 × 10⁻⁵ | 5.64 × 10⁻⁶ | 5.45 × 10⁻⁵ | 7.43 × 10⁻⁶ | 8.54 × 10⁻⁵ |

| | | | | | | |
|---|---|---|---|---|---|---|
| 150-75-5 | 1 | 4.16 × 10⁻⁶ | 4.53 × 10⁻⁵ | 4.46 × 10⁻⁶ | 6.15 × 10⁻⁵ | Data N.A. |
| | 2 | 3.93 × 10⁻⁶ | 3.64 × 10⁻⁵ | 6.40 × 10⁻⁶ | 1.29 × 10⁻⁶ | Data N.A. |

| | | | | | |
|---|---|---|---|---|---|
| 150-75-16 | 1 | 5.00 × 10⁻⁶ | 6.12 × 10⁻⁵ | Data N.A. | Data N.A. |
| | 2 | 4.13 × 10⁻⁶ | 4.59 × 10⁻⁵ | Data N.A. | Data N.A. |
| 150-75-25 | 1 | 4.73 × 10⁻⁶ | 9.73 × 10⁻⁵ | Data N.A. | Data N.A. |
| | 2 | 3.53 × 10⁻⁶ | 4.27 × 10⁻⁵ | Data N.A. | Data N.A. |

NA - standard deviation exceeded approx. 50%

### EXAMPLE 13

### Solvent Hydrophobicity Affects Polymerization

The protocol called for this experiment was the same as that described in Example 7.

In this study two solvent systems were used to determine how solvent hydrophobicity would affect the polymerization. One method used BDDA (300 μL) in 3.0 mL of casting solvent (1:1:3 ethanol: buffer pH=7: acetonitrile) while the other method used BDDA (300 μL) in 3.0 mL of octanol. These solutions were flushed through the capillaries containing ODS beads and the polymerization was initiated using 254 nanometer light for 90 seconds.

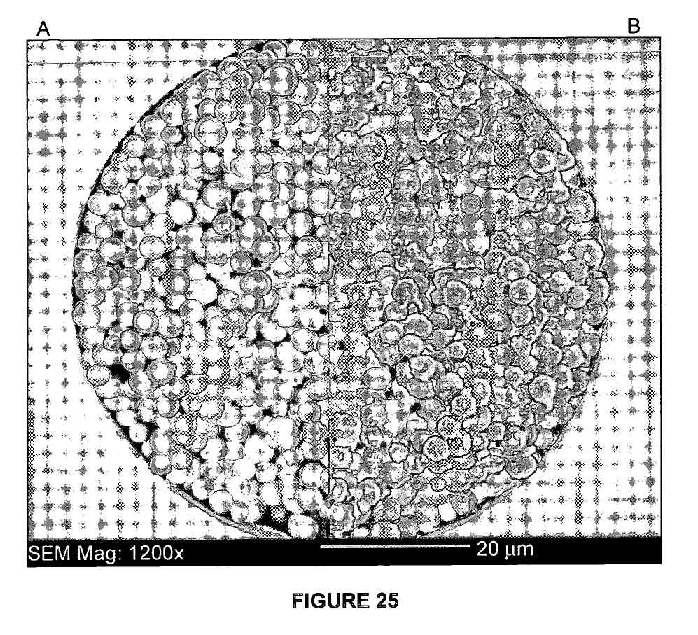

FIG. 25 shows side-by-side scanning electron micrographs of ODS particles entrapped using a hydrophilic solvent (A) and a hydrophobic solvent (B). FIG. 25 shows that the entrapped particles of A have minimal polymer formation and only have polymer at bead-to-bead contact points and bead-to-wall contact points. In contrast, the entrapped particles of B show indiscriminate polymer formation all over the surface of the beads as well as bead-to-bead contact points and bead-to-wall contact points.

### EXAMPLE 14

### Material can be Controlled with Choice of Monomer

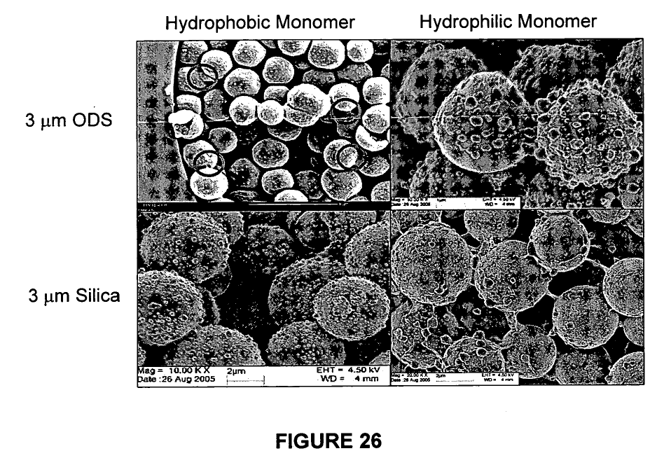

FIG. 26 shows ODS particles entrapped using hydrophobic monomer and hydrophilic solvent (A) according to methods of the present invention. The scanning electron micrograph of A shows substantially unoccluded openings between the particles with little coverage of the particles with the polymer. However, when a hydrophilic monomer and hydrophilic solvent system was used with the ODS particles (B), substantial coverage or encapsulation of the particles resulted. With silica particles, the particles were entrapped with hydrophilic monomer and hydrophilic solvent (D). Polymer can be observed making contact between particles while leaving channels substantially unoccluded and leaving little polymer on the particles. However, when a hydrophobic monomer and hydrophilic solvent system was used with the silica particles (C), encapsulation resulted.

Comparison of Present Invention with Art-Recognized Methods and Compositions

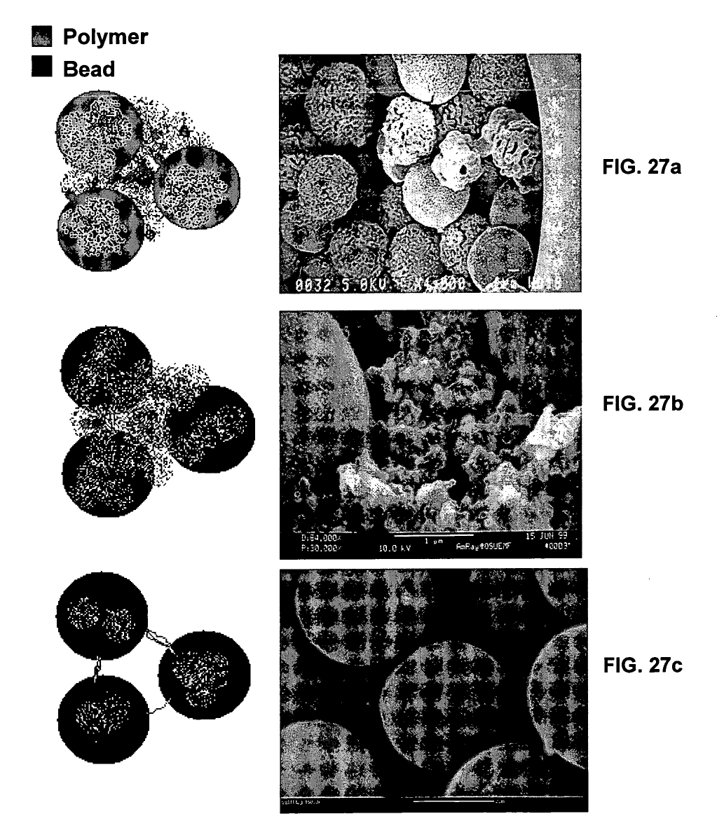

FIG. 27 shows a direct comparison of the present invention (shown as 3 in FIG. 27) with entrapping using Sol-Gel and thermally initiated PPM. The present invention provides entrapped particles in minutes as opposed to hours, and leaves much of the beads advantageously exposed.

All third party documents referred to herein are hereby incorporated by reference

While specific exemplary embodiments have been discussed herein, other variations, combinations and embodiments will now occur to those of skill in the art and are encompassed by the invention.

1. An emitter comprising
a plurality of particles collectively forming a plurality of channels, and
a polymeric material adhesively disposed between at least a portion of adjacent said particles,
wherein the channels are substantially unoccluded by the polymeric material.

2. The emitter of claim 1 wherein the polymeric material forms a porous polymer monolith.

3. The emitter of claim 1 wherein the polymeric material forms a substantially non-porous matrix.

4. The emitter of claim 1 wherein the polymeric material is polyolefin.

5. The emitter of claim 4 wherein the polyolefin is selected from the group consisting of polyacrylates, polymethacrylates, polystyrenes, and mixtures thereof.

6. The emitter of claim 1 wherein a substantial amount of the surface area of the particles is uncovered by the polymer and available to interact with a sample.

7. The emitter of claim 1 wherein the particles comprise at least one material selected from the group consisting of inorganic oxides, metal oxides, silica, alumina, titania, zirconia, chemically bonded inorganic oxides, chemically bonded metal oxides, organosiloxane-bonded phases, hydrosilanization/hydrosilation bonded phases, polymer coated inorganic oxides, porous polymers, polyolefin, polystyrene, polymethacrylate, polyacrylate, and styrene-divinylbenzene copolymer.

8. The emitter of claim 1 wherein the particles are metal oxide-coated.

9. The emitter of claim 8 wherein the particles comprise polyolefin.

10. The emitter of claim 9 wherein the polyolefin is polystyrene.

11. The emitter of claim 10 wherein the particles are coated with pepsin enzyme.

12. The emitter of claim 10 wherein the particles are magnetic.

13. The emitter of claim 10 wherein the particles are paramagnetic.

14. The emitter of claim 1 wherein the particles are nonporous particles.

15. The emitter of claim 1 wherein the particles are porous particles.

16. The emitter of claim 15 wherein the particles have pores with a diameter in the range of about 100 to about 300 angstroms.

17. The emitter of claim 15 wherein the particles have pores with a diameter greater than 300 angstroms.

18. The emitter of claim 15 wherein the particles have pores with a diameter less than 100 angstroms.

19. The emitter of claim 1 wherein the particles have a diameter in the range of about 0.1 micrometres to about 1000 micrometres.

20. The emitter of claim 1 wherein the particles have a diameter in the range of about 0.3 micrometres to about 600 micrometres.

21. The emitter of claim 1 wherein the particles have a diameter in the range of about 0.5 micrometres to about 300 micrometres.

22. The emitter of claim 1 wherein the channels have a diameter in the range of about 0.2 micrometres to about 30 micrometres.

23. The emitter of claim 1 wherein the channels have a diameter in the range of about 0.5 micrometres to about 10 micrometres.

24. The emitter of claim 1 wherein the channels have a diameter in the range of about 1.0 micrometres to about 5.0 micrometres.

25. The emitter of claim 1 wherein the surface of at least one particle is suitable to interact with at least one component of a sample flowing through the channels.

26. The emitter of claim 1 further comprising a vessel for containing the plurality of particles.

27. The emitter of claim 26 wherein the vessel is a capillary.

28. The emitter of claim 27 wherein the capillary has an inner diameter of about 0.2 to about 1000 micrometres.

29. The emitter of claim 27 wherein the capillary has an inner diameter of about 30 to about 500 micrometres.

30. The emitter of claim 27 wherein the capillary has an inner diameter of about 50 to about 250 micrometres.

31. The emitter of claim 27 wherein the capillary has an inner diameter of about 1 to about 100 micrometres.

32. Use of an emitter comprising
a plurality of particles collectively forming a plurality of channels, and
a polymeric material adhesively disposed between at least a portion of adjacent said particles,
wherein the channels are substantially unoccluded by the polymeric material to provide a sample suitable for analysis by mass spectrometry.

33. The use of claim 32 wherein the mass spectrometry is micro-electrospray mass spectrometry.

34. The use of claim 32 wherein the mass spectrometry is nano-electrospray mass spectrometry.

35-65. (canceled)

66. Use of a composition comprising
a plurality of particles collectively forming a plurality of channels, and
a polymeric material adhesively disposed between at least a portion of adjacent said particles,
wherein the channels are substantially unoccluded by the polymeric material to provide a sample suitable for analysis by a mass spectrometer.

67-70. (canceled)
